(19) United States
(12) Patent Application Publication
(10) Pub. No.: US 2022/0168924 A1
(43) Pub. Date: Jun. 2, 2022

(54) TILE SAW

(71) Applicant: Black & Decker, Inc., New Britain, CT (US)

(72) Inventor: Peter CHAIKOWSKY, Forest Hill, MD (US)

(21) Appl. No.: 17/676,448

(22) Filed: Feb. 21, 2022

Related U.S. Application Data
(63) Continuation of application No. PCT/US2020/047258, filed on Aug. 20, 2020.
(60) Provisional application No. 62/890,280, filed on Aug. 22, 2019.

(51) Int. Cl. B28D 1/04; B23D 47/02

(52) U.S. Cl. CPC B28D 1/047; B23D 47/025

(57) ABSTRACT

A tile saw for cutting tile includes a frame assembly on which a rail assembly is mounted and a table assembly that is movable along the rail assembly. The table assembly includes a table and wheels mounted on the underside thereof that move the table along the rail assembly. The table assembly can cantilever with respect to the frame assembly by the travel of the wheels along the rail assembly. By cantilevering the table assembly, a wide variety of sizes of tiles can be cut without increasing the length of the rails to accommodate larger tile. The saw assembly also includes an asymmetrical C-shaped column assembly that increases the tile size capacity of the tile saw without increasing the table size.

### CROSS-REFERENCE TO RELATED APPLICATIONS

This application claims priority to U.S. Provisional Patent Application Ser. No. 62/890,280 entitled “Tile Saw”, filed Aug. 22, 2019. The entirety of the above application incorporated herein by reference.

### FIELD OF THE INVENTION

This invention relates generally to tile or masonry saws and, more particularly, to tile saws with expanded capacity.

### BACKGROUND OF THE INVENTION

A typical tile saw includes a base which supports a generally flat tabletop. A saw unit may be disposed on the base or table for cutting a workpiece, such as a tile or masonry brick, disposed on the table. However, the maximum cutting capacity of such tile saws is limited by the size of the machine or “envelope.”.

Accordingly, persons skilled in the art have devised a tile saw where the base has two tracks and the table has bearings or wheels riding on the tracks, so that the table can be moved relative to the saw unit for increased capacity. Such tile saws, however, are usually susceptible to dust collecting between the tracks and wheels, which creates binding between the base and the table. Ultimately, the binding may cause uneven, inaccurate cuts, which may translate into loss of time, materials and/or profit for the user.

Further, the capacity of such tile saws is usually limited to the length of the tracks. In other words, if a user wants increased capacity, the user may have to lengthen the tracks. However, longer tracks may result in less portability of the tile saw.

It is therefore an object of this invention to provide a saw with increased cutting capacity without sacrificing portability.

### SUMMARY OF THE INVENTION

In accordance with the present invention, an improved tile saw is employed. The saw comprises a base, a frame assembly disposed on the base, a rail disposed on the frame assembly, the rail having a longitudinal axis, a table movably disposed on the rail, a support assembly disposed on the base, a saw assembly supported by the support assembly. The saw assembly includes a motor and a cutting wheel driven by the motor. The saw assembly is pivotable about a horizontal axis substantially parallel to the longitudinal axis, and a switch is electrically connected to the motor.

In an embodiment, the tile saw includes wheels fixed to the bottom of a table that move along a pair of parallel rails. The wheels can support the table assembly in at least a first cantilevering position on a longitudinal side of the cutting wheel. In the cantilevering position, at least two wheels extend beyond the end of the rail assembly and are not in contact with (off of) the rail assembly. The same two wheels that are off of the rail assembly in a first cantilevering direction support the table assembly in a second cantilevering position on an opposite second longitudinal side of the cutting wheel. In an embodiment, the spacing between the wheels at the ends of the table assembly can be less than the spacing between the wheel set in the center of the table. This increases the capacity of the saw assembly while keeping the overall size of the saw assembly 10 smaller.

In an embodiment, the saw assembly includes the base and the frame assembly is disposed on the base. A rail assembly disposed on the frame assembly. The rail assembly has a longitudinal axis, a first end and a longitudinally opposite second end. The rail assembly includes a rail having a length. A support assembly is disposed on at least one of the base and the frame assembly and includes a motor, and a cutting wheel driven by the motor. The cutting wheel has a cutting wheel axis that lies in a cutting wheel axis plane. A table assembly having a table body is movably disposed on the rail assembly between a first cantilevered position with respect to the frame assembly at the first end of the rail assembly, and a second cantilevered position with respect to the frame assembly at the second end of the rail assembly. A plurality of wheels is serially arranged on the table body to move the table assembly along the rail assembly between the first cantilevered position wherein at least two of the plurality of wheels are moved beyond the first end of the rail assembly, and the second cantilevered position wherein at least two of the plurality of wheels are moved beyond the second end of the rail assembly.

In an embodiment, the rail assembly can include a rod disposed along the longitudinal axis thereof, the rod having a first end and an opposite second end. The plurality of wheels can move the table assembly along the rod between the first cantilevered position wherein at least two of the plurality of wheels are moved beyond the first end of the rod, and the second cantilevered position wherein at least two of the plurality of wheels are moved beyond the second end of the rod.

In an embodiment, the rail assembly can include a contact portion disposed along the longitudinal axis and having a first end and an opposite second end. The plurality of wheels can move the table assembly along the contact portion between the first cantilevered position wherein at least two of the plurality of wheels are moved beyond the first end of the contact portion, and the second cantilevered position wherein at least two of the plurality of wheels are moved beyond the second end of the contact portion.

In an embodiment, the plurality of wheels includes a first end wheel disposed at one end of the table body, a second end wheel disposed at an opposite end of the table body and middle wheels located between the first end wheel and the second end wheel. The distance between each end wheel and an adjacent middle wheel is greater than the distance between adjacent middle wheels. Each of the first end wheel, second end wheel and middle wheels having axes. A ratio of the distance between the first end wheel axis and the second end wheel axis to the length of the rail is less than 1.25.

In an embodiment, in the first and second cantilevered positions, the table assembly can be cantilevered to a maximum cantilevered span with respect to the frame assembly and a travel length of the table assembly along the rail is about two times the length of the rail.

In an embodiment, in the maximum cantilevered span position, a ratio of the distance between the cutting wheel axis plane and first end wheel axis plane to the length of the rail is greater than one.

In an embodiment, the rail assembly includes parallel first and second rails arranged on the frame assembly, each of the first and second rails having a first end and an longitudinally opposite second end. A plurality of bearings is serially arranged on the table assembly, to support the table assembly along the first and second rails between the first cantilevered position wherein at least two bearings are moved beyond the first end of the first and second rails, and the second cantilevered position wherein at least two bearings, are moved beyond the second end of the first and second rails.

In an embodiment, a saw assembly includes a base, a frame assembly disposed on the base and a rail assembly disposed on the frame assembly. The rail assembly has a longitudinal axis, a first end and a longitudinally opposite second end. The rail assembly includes a rail having a length. An arm assembly supporting a motor assembly is disposed above the table assembly. The motor assembly includes a motor and a cutting wheel driven by the motor. The cutting wheel has a cutting wheel axis that lies in a cutting wheel axis plane. A column assembly supporting the arm assembly includes at least one connecting end portion defining a connecting end plane and a central portion defining a central portion plane. The central portion plane is obliquely angled with respect to the connecting end plane, for example, at about 45°. The connecting end plane is perpendicular to the longitudinal axis of the rail and the central portion plane forms an acute angle with the connecting end plane. In an embodiment, the column assembly has an asymmetrical C-shaped body.

In an embodiment, at least one connecting end portion can be a first portion disposed on at least one of the base and the frame assembly and define a first portion plane parallel to the cutting wheel axis plane. The central portion can be a second portion defining a second portion plane obliquely angled with respect to the first portion plane. The second portion can include a forward contact point that lies in a contact point plane parallel to the cutting wheel axis plane. In an embodiment, a distance between the forward contact point plane and the cutting wheel axis plane is at least 6 inches. In an embodiment the at least one connecting end portion includes two connecting portions, one portion connected to one of the base and frame assembly and the other portion connected to the arm assembly.

In an embodiment, the first portion defines a first surface plane parallel to the cutting wheel axis plane, and a second portion defines a second surface plane obliquely angled with respect to the first surface plane. The second portion having a contact point that lies in a contact point plane. The distance between the first surface plane and the contact point plane is greater than zero.

In an embodiment, a table positioning knob assembly includes a knob body including an upper surface having a protruding member and a bottom surface having a positioning members including a detent member, such as a ball. The knob body is moveable to a plurality of positions such as by rotating about a knob shaft. The knob shaft rotatably supports the knob body through the plurality of positions. Positioning elements including a pin and detent grooves cooperate with the positioning members on the knob body to position the knob body at each of the plurality of positions. A spring biases the knob body in a direction toward the positioning element.

In an embodiment, the table has a longitudinal length and is movably disposed on the rail. The table includes a table body having a top surface for supporting a workpiece and a bottom surface comprising at least one first and second depending brackets arranged longitudinally on the table and offset from each other. The table positioning knob assembly is disposed on the frame and is configured to engage at least one of the plurality of depending brackets to retain the table on the frame at different positions along the length of the rail. The plurality of positions includes a first position over the base and a second cantilevered position with respect to the frame. In a third position of the knob body, the projecting member engages nether bracket and the table can be removed from the rail.

In an embodiment, of the support assembly in the saw assembly, the motor has a motor shaft rotatable on a motor shaft axis that lies in a plane parallel to the top surface of the table body. The cutting wheel is driven by the motor shaft. During movement of the motor toward the table assembly or during operation of the saw with the motor running, the motor shaft axis deflects less than 5.21 mm toward the top surface of the table.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIGS. 1A-1B are front perspective and side views of a tile saw according to an embodiment of the invention;

FIG. 2 is a rear perspective view of the tile saw illustrated in FIGS. 1A and 1B;

FIG. 3 illustrates a frame assembly according to an embodiment of the invention;

FIGS. 4A-4E illustrates a first embodiment of the rail and table assemblies according to the present invention, where FIGS. 4A and 4B are partial cross-sectional views along line A-A of FIG. 1 and line B-B of FIG. 1A, FIG. 4C is the underside of the table assembly, FIG. D is a side view along line D-D of FIG. 1A and FIG. 4E illustrates a kerf in a top perspective view of the table assembly according to the present invention;

FIGS. 5A-5B illustrate a detail of the rail and table assemblies of FIG. 4;

FIGS. 6A-6B illustrate the cutting capacity of the tile saw according to the invention; FIG. 6B illustrates the side and a partial top view of FIG. 6A with an exemplary workpiece;

FIGS. 7A and 7B illustrate side views of the table assembly in cantilevered positions;

FIGS. 8A-8I illustrates a table positioning knob that controls the extent to which the table cantilevers or is removed from the frame;

FIG. 9 is a partial cross-sectional view of grooves in a table assembly according to the present invention;

FIGS. 10A-10B are top views of a table assembly with a first embodiment of an extension pan assembly according to the present invention;

FIGS. 11A-11C are rear perspective views of the saw assembly and exemplary extension pan positions;

FIGS. 12A-12F illustrate front, rear, side and top views, of the column assembly according to the present invention;

FIGS. 13A-13C illustrate the front, rear and left perspective views of the arm and motor assemblies according to the present invention;

FIG. 14 illustrates the blade at two different bevel positions;

FIG. 15 illustrates a side view of a depth stop mechanism according to the invention;

FIG. 16 is a circuit schematic of the tile saw according to the present invention;

FIG. 17 illustrates opposing sides of an adjustable guard assembly according to the present invention;

FIGS. 18A-18B illustrate a fluid nozzle assembly according to the present invention, where the fluid nozzle assembly is in the detached and attached positions, respectively;

FIG. 19 is a side view of the tile saw with a flexible nozzle assembly according to the present invention;

FIGS. 20A-20B are front and side views of the lower portion of the nozzle assembly, respectively;

FIG. 21 is a partial perspective view of the fluid nozzle assembly with a detached hose;

FIG. 22 is a side view of a portion of the guard assembly;

FIG. 23 is a partial cross-sectional view of the guard assembly with a flap assembly;

FIGS. 24B-24C illustrate partial cross-sectional views of the fluid direction mechanisms within the motor housing along lines D-D and E-E of FIG. 24A, respectively, where FIG. 24A is a front view of the motor assembly;

FIGS. 25A-25B are a partial side view and full side view, respectively, of the tile saw supported by a stand;

FIGS. 26A-26B illustrate two alternate designs of an angle guide assembly, a perspective view of the first design and a partial exploded view of the second design, respectively;

FIG. 27 illustrates partial cross-sectional views of an angle guide clamping mechanism; and

FIG. 28 illustrates the table having a carry handle and a fence.

### DETAILED DESCRIPTION

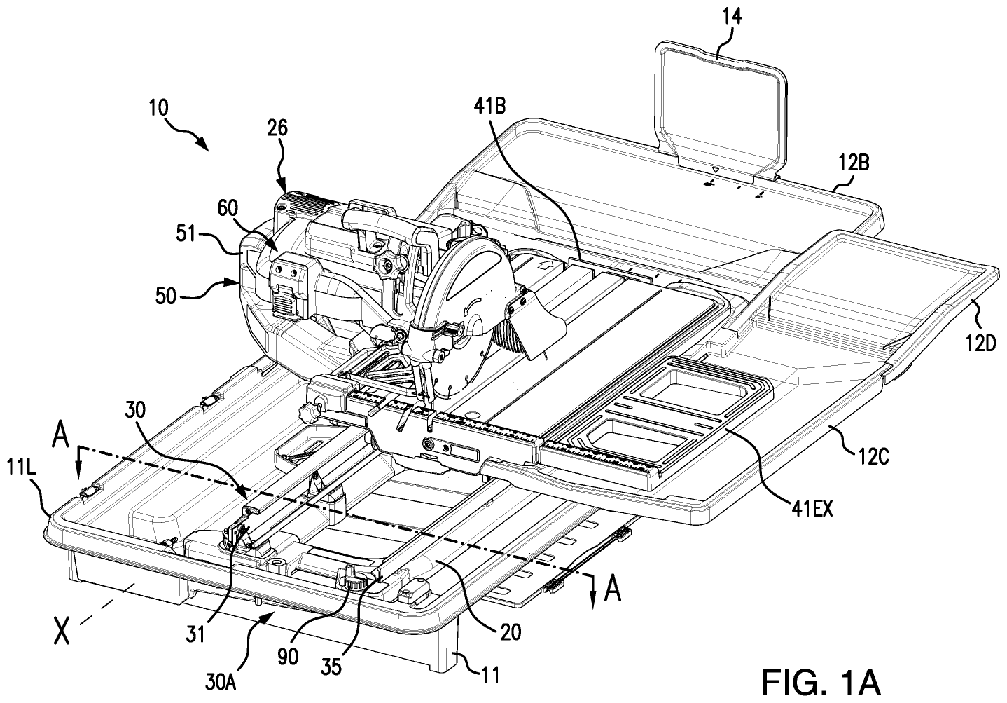

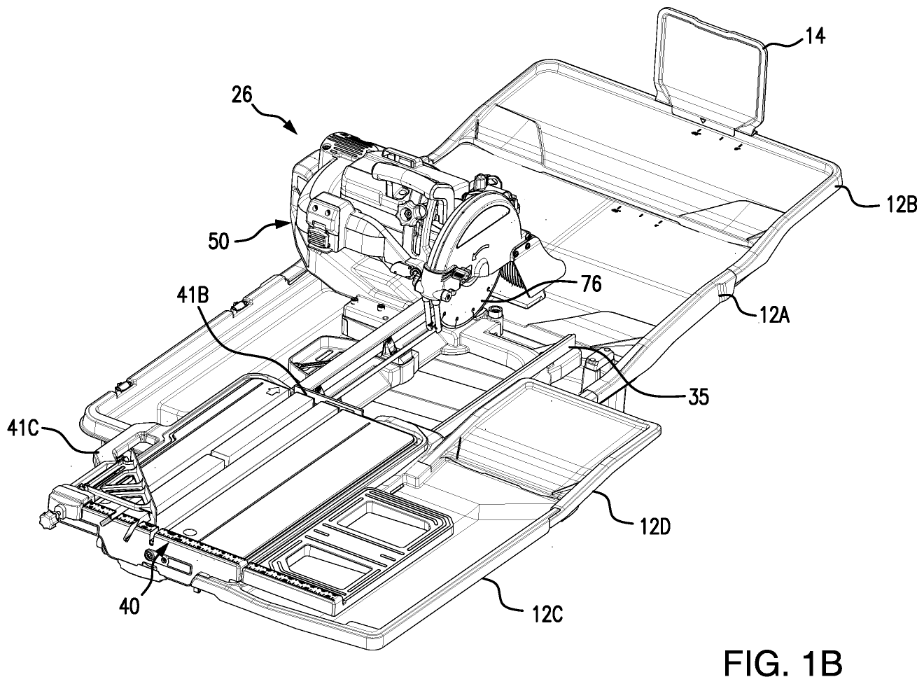

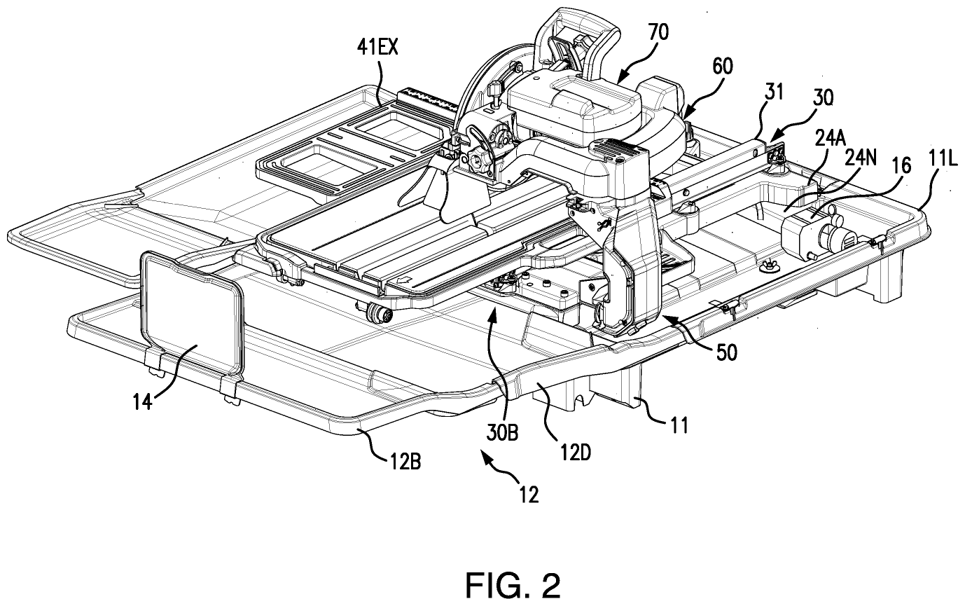

The invention is now described with reference to the accompanying figures, wherein like numerals designate like parts. FIGS. 1A, 1B and 2 illustrate a first embodiment of the present invention, where a tile saw 10 comprises a base 11. A frame assembly 20 may be disposed on base 11. Frame assembly 20 may support rail assembly 30 and table assembly 40. Rail assembly 30 has a longitudinal axis X disposed in a longitudinal direction of the tile saw 10, and has a first end 30A and a second end 30B. Table assembly 40 is movable along rail assembly 30 in the longitudinal direction. Table assembly 40 includes a table body 41 for supporting a workpiece. A side table extension 41EX provides additional support for workpieces that are wider than the width of the table body 41. Frame assembly 20 may also support a support assembly 26 that supports several actuating members of the tile saw. The support assembly 26 is disposed on at least one of the base 11 and the frame assembly 20. The support assembly 26 includes a column assembly 50, which in turn may support an arm assembly 60. Arm assembly 60 may support motor assembly 70, which includes a motor 78M and a cutting wheel 76 for cutting a workpiece (not shown), such as tile, disposed on table assembly 40 and moved into contact with the cutting wheel 76. The motor 78M includes a motor shaft 72 for driving the cutting wheel 76. The cutting wheel defines a cutting wheel plane P_{CW} that is perpendicular to the cutting wheel rotation axis WA.

FIG. 1A illustrates the table body 41 of the table assembly 40 in a first position and FIG. 1B illustrates the table in a second position after moving along the rail assembly 30 in a longitudinal direction. The base 11 supports the frame assembly 20 and the different elements of the tile saw 10 as described below.

Base 11 is preferably injection molded or vacuum formed. Base 11 may be made of any material, including, but not limited to polypropylene with calcium carbonate filler, such as Astryn 75A6-2 by Basell, HDPE (High Density Polyethylene) or ABS.

As is well known in the art, base 11 can include a tub portion mounted thereon. In an embodiment, the base can be shaped as a tub to receive most, if not all, the water and slurry created during operation. A pump 16 can be disposed on base 11 to pump fluid out of base 11.

Base 11 may support frame assembly 20. Referring to FIGS. 1A-3, frame assembly 20 may have a body 21 with front 24A and rear 24B extensions. Base 11 may have notches 24N which receive front and rear extensions 24A, 24B.

Preferably, frame assembly 20 is made of cast aluminum. Such material is advantageous as it reduces the flex caused by the tile saw components disposed thereon, providing a more accurate cut.

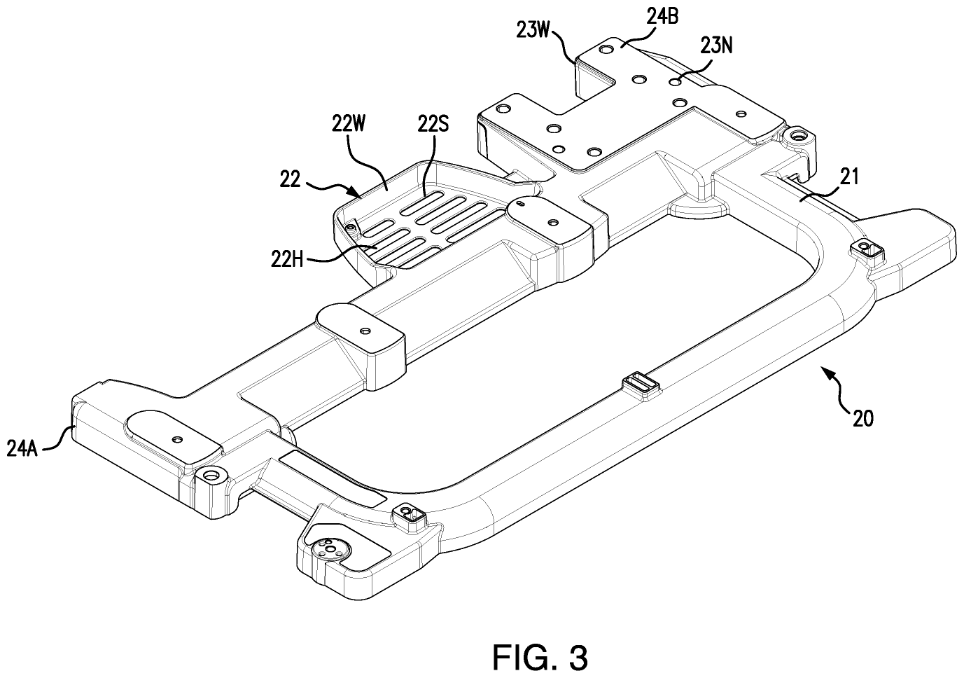

Frame assembly 20 may have integral storage areas for storing tile saw components thereon. For example, as shown in FIG. 3, frame assembly 20 may have a pump holder assembly 22. Pump holder assembly 22 may include a shelf 22S extending from body 21 for holding pump 16 during transport. Shelf 22S may have holes 22H thereon to allow fluid and slurry to fall therethrough, away from the tile saw. A wall 22W disposed around shelf 22S may retain pump 16 within the pump holder assembly. A support pad 23 is mounted to the rear extension 24B.

Referring to FIGS. 1A-1B, 2, and 12A, the column assembly 50 can be disposed on and supported by at least one of the base 11 and the frame assembly 20. The column assembly 50 can be a arranged on a lateral side of the cutting wheel plane P_{CW} and extend generally horizontally from the table assembly 40. Column assembly 50 preferably includes a column body 51. In an embodiment, the body 51 can be attached to a frame assembly, such as the frame assembly illustrated in FIG. 3. The body 51 can be secured by screws 23S onto the support pad 23 of frame assembly 20.

In order to provide a means to ensure proper alignment between the column assembly 50 and frame assembly 20, posts 23W, 23N may be provided on support pad 23 and/or column body 51. FIG. 3, for example, illustrates the posts 23W, 23N on the frame assembly 20. These posts are received in corresponding holes in column body 51 and/or support pad 23. Preferably, post 23W is wider than post 23N. Accordingly, the user need only dispose body 51 onto support pad 23. The posts 23W, 23N (and the corresponding holes) enable the user to quickly locate the proper position of column assembly 50 relative to frame assembly 20. As shown in FIG. 2, once located, the user need only affix column assembly 50 to frame assembly 20 by screws 23S.

Persons skilled in the art will recognize that the holes receiving posts 23W, 23N are preferably close tolerance holes. In order to allow both posts 23W, 23N to fit in both holes, some side-to-side allowance for one of the holes should be provided. This side-to-side allowance could be achieved by making one of the holes into a slot, or shaping one post as a diamond, in a similar manner as post 51D.

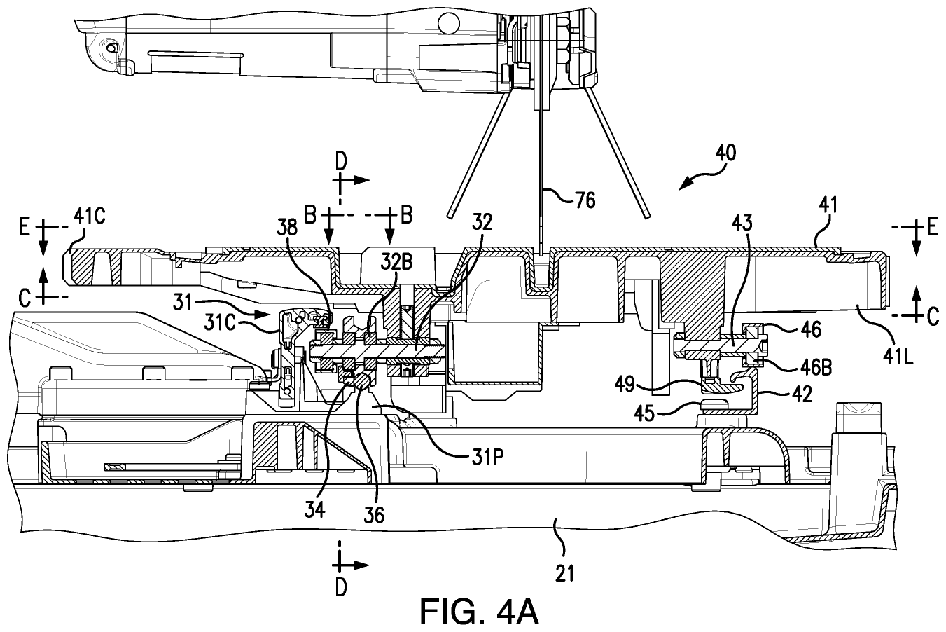

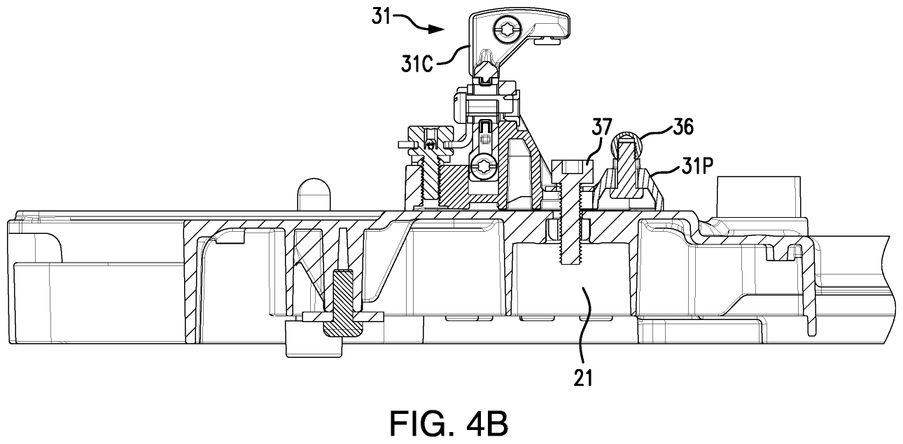

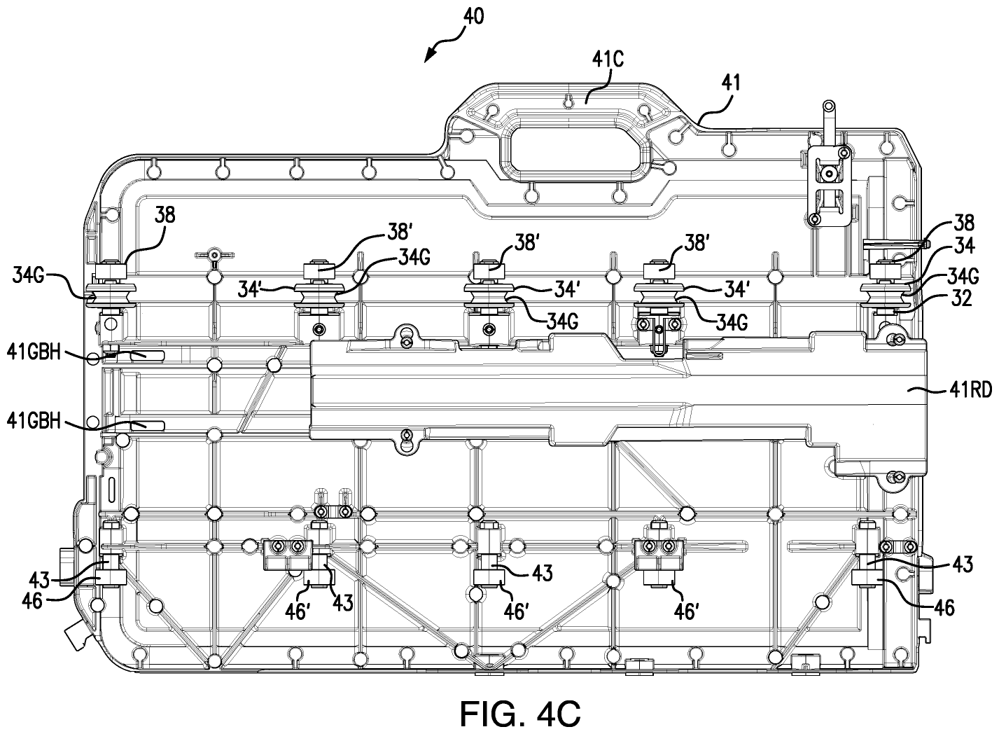

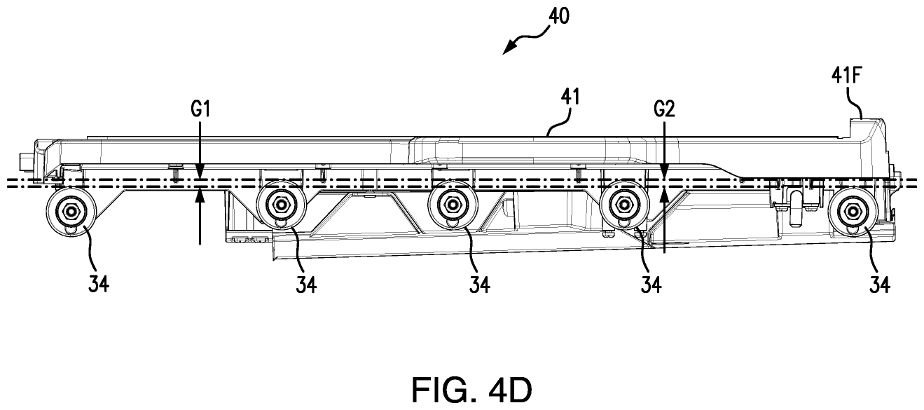

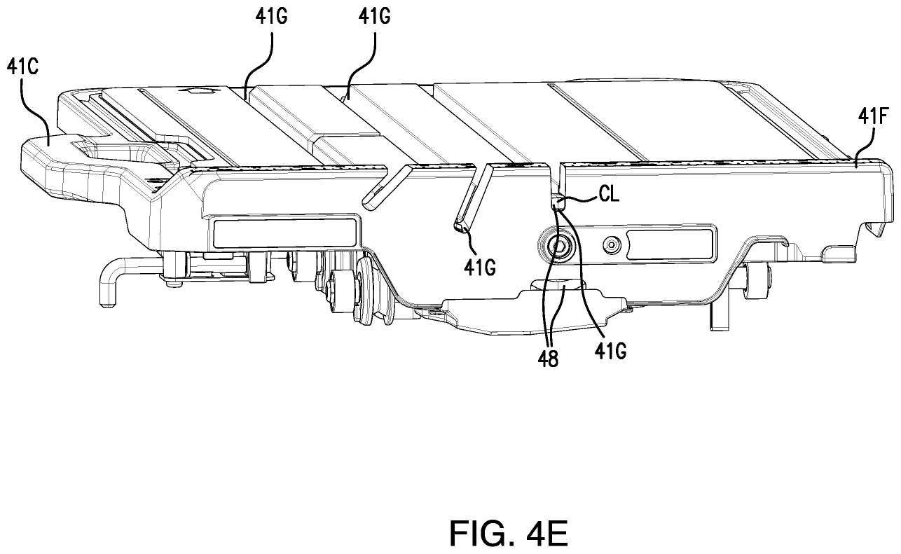

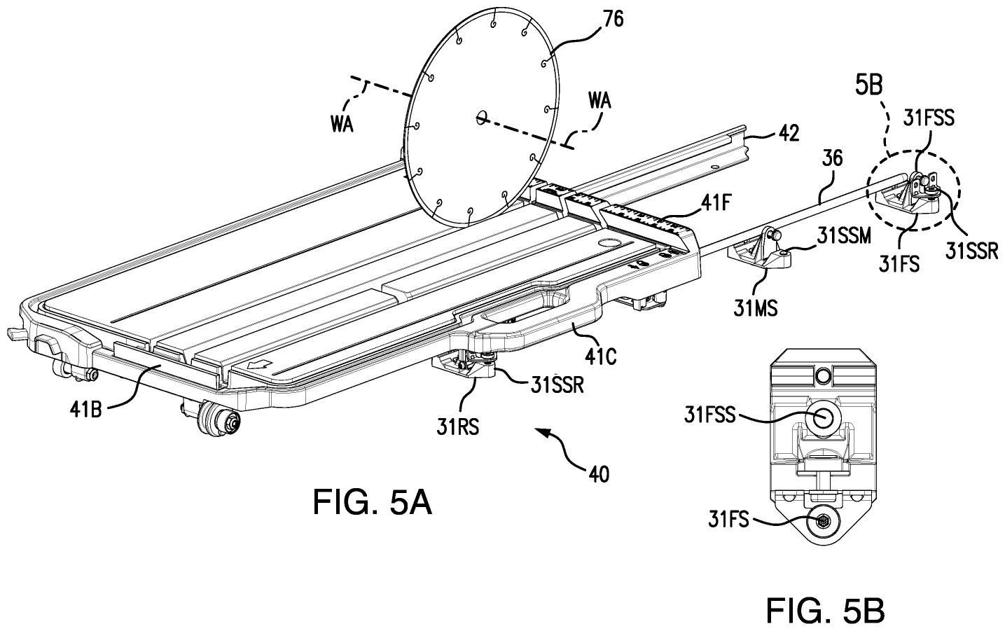

Referring to FIGS. 4A, 4B, 5A- and 5B, frame assembly 20 may support rail assembly 30. Rail assembly 30, in turn, preferably supports table assembly 40. A first embodiment of rail assembly 30 may include a first rail 31 and a second rail 42. Both rails 31 and 42 can be supported by frame assembly 20 and have equal lengths. Both first and second rails 31, 42 may be made of extruded or cast aluminum or steel.

As shown in FIGS. 4A and 4B, first rail 31 is preferably fixed to frame assembly 20 by a first bolt and nut combination 37. First rail 31 may have a first portion 31C which is substantially C-shaped in cross-section throughout a major portion, if not all, of its entire length. The first portion 31C may include a contact portion 33, such as a surface, along which table assembly 40 is movable. In addition, first rail 31 may include a second portion 31P. The second portion 31P may include a contact portion in the form of a rod 36 disposed in a longitudinal direction. The rod 36 has a first end 36 and an opposite second end 36B that substantially corresponds in length to the first end 30 and second end 30B of the overall rail assembly 30. First and second portions 31C, 31P may be interconnected. Preferably rod 36 lies outside of the first portion 31C. Rod 36 can be made of steel.

Second rail 42 is preferably fixed to frame assembly 20 by a second bolt and nut combination 45. Second rail 42 preferably has a substantially L-shaped or C-shaped cross-section throughout a major portion, if not all, of its entire length.

Table assembly 40 is preferably movably disposed to rail assembly 30. In an embodiment, table assembly 40 rolls or slides on rail assembly 30. To facilitate this movement, table assembly 40 may also include several shafts 32, 43, wheels 34 and bearings 38, 46 connected to table body 41.

As shown in FIGS. 4A and 4C, first shafts 32 are connected to the underside of table body 41 and support a plurality of serially arranged wheels also connected to the underside of table body 41. First shafts 32 may be supported by shaft bearings 32B disposed between table body 41 and shafts 32. Shaft bearings 32B may be ball or roller bearings. In an embodiment, shafts can be connected to any portion of the table body that allows the table body to move in a predetermined direction. For example, shafts can be connected to side portions of the table body.

Wheels 34, 34′ may be disposed on one side of table body 41 and arranged to ride on first rail 31. Each wheel 34, 34′ may be disposed on shaft 32. Shaft bearings 32B may also be disposed between wheel 34, 34′ and shaft 32. Preferably, two shaft bearings 32B are pressed into each wheel 34, 34′. In addition, a first table bearing 38 may be disposed on first shaft 32. First table bearing 38 may be a rotatable roller or a non-rotatable element which may be polygonnally shaped. Preferably, shafts 32, wheels 34, 34′ and first table bearings 38 are disposed on one side of table body 41. In an embodiment, the number of wheels 34, 34′ on one side of table body 41 is greater than three. In another embodiment, shown in FIG. 4C, the number of wheels 34, 34′ on one side of table body 41 is greater than four. In a further embodiment, the number of wheels 34, 34′ on one side of table body 41 is greater than five.

At least one second table bearing 46 may be disposed on the other side of table body 41 and arranged to ride on second rail 42. Second table bearing 46 may be a rotatable roller, as shown in FIG. 4A. Second table bearing 46 may be disposed on a shaft 43 connected to table body 41. Shaft(s) 43 may be fixedly attached to table body 41. Alternatively, shaft 43 may be supported by a non-rotatable element, such as linear bearing 49 shown in FIG. 4A. Such a linear bearing 49 may ride on second rail 42 or travel underneath second rail 42 so that the user cannot pull up such end beyond second rail 42.

Second table bearing 46 preferably rides on second rail 42. Internal bearings 46B also allow second table bearing 46 to rotate on second shaft 43.

With such an arrangement, table assembly 40 may be movably disposed on rail assembly 30 in the longitudinal direction (as shown in FIG. 1A). In particular, wheels 34, 34′ may be disposed on first rail 31. For example, wheels 34 may be disposed on rod portion 36 of first rail 31, while first rail bearings 38 are disposed within first portion 31C and second table bearings 46 are disposed on second rail 42, respectively.

Preferably, wheels 34, 34′ and first table bearings 38 support most, if not all, of the weight of table body 41. In the present arrangement, table body 41 preferably pivots about the contact between rod 36 and wheels 34, 34′. Referring to FIG. 4A, as table body 41 rotates in a clockwise direction, first table bearings 38 contact the inside portion of first portion 31C.

Table body 41 may thus be moved in a direction parallel to the longitudinal axes of first and second rails 31, 42. When table body 41 is moved accordingly, wheels 34 rotate about and/or with shafts 32, while first table bearings 38 slide along first portion 31C.

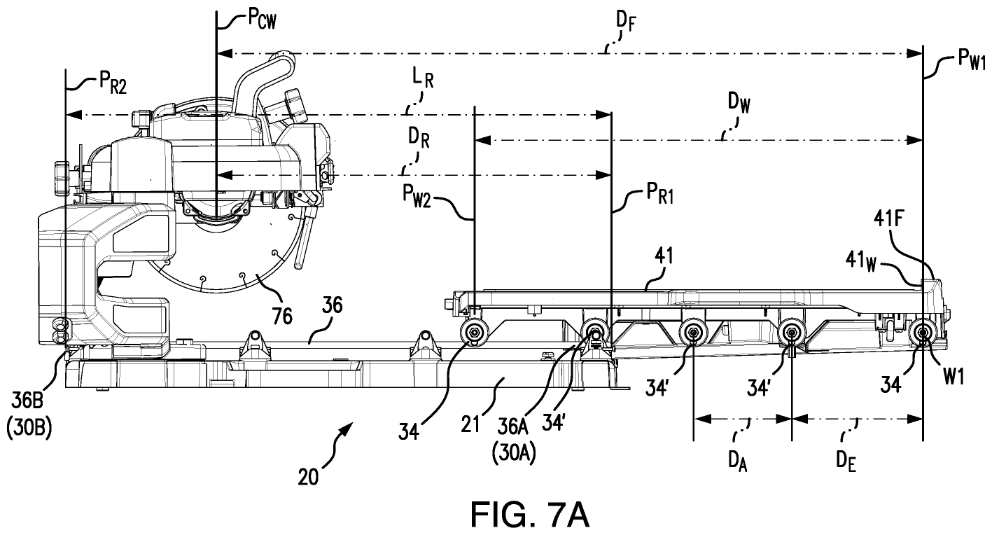

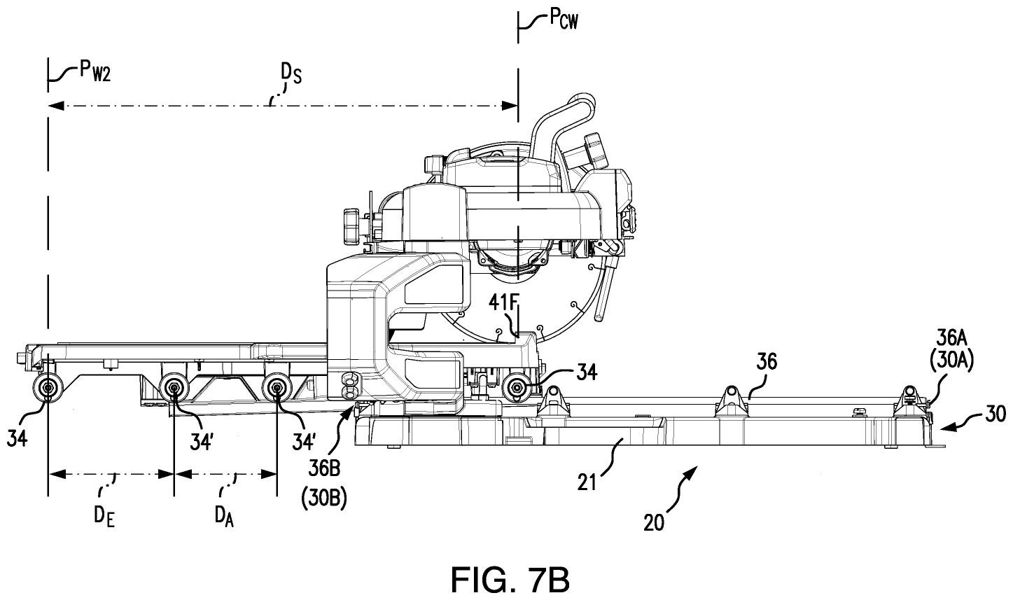

This arrangement of a plurality of wheels serially arranged on the underside of table body 41 is especially advantageous as it allows the user to move table assembly 40 beyond the ends of rail assembly 30, as shown in FIGS. 7A and 7B. Persons skilled in the art will recognize that, as each wheel 34, 34′ moves beyond the first end 36A and second end 36b of rod 36 (except for one, two or three of the rearmost or frontmost wheels 34), first table bearings 38 will contact the inside, upper portion of first rail portion 31C to support table assembly 40 in cantilevered positions at opposite ends of first rail 31. Similarly, linear bearings 49 will contact the inside upper portion of second rail 42 to support table assembly 40 in a cantilevered positions.

A cantilevered position includes, but is not limited to, a position in which a portion of table assembly 40 extends beyond the opposing ends of rail assembly 30 and components and portions thereof. In an embodiment, the top surface of table body 41 remains substantially parallel to rail assembly 30 in the cantilevered position. Table assembly 40 cantilevers with respect to frame assembly 20. A cantilevered position also includes table assembly 40 positioned at a maximum cantilevered span with respect to frame 21. In the maximum cantilevered span position, table assembly 40 is cantilevered to its maximum distance beyond either the first end 30A or second end 30B of the rail assembly 30, such as by the wheels 34 reaching its furthest travel point along the rail assembly, or by being mounted on the rail assembly in the cantilevered position. In an embodiment, the maximum distance point can be measured at the cantilevered first or far end of the table. In an embodiment, the maximum distance point can be measured at the inner surface of the fence 41F. Preferably, the maximum distance point can be measured at the axis of the wheels 34 located at the longitudinal end of the table assembly or farthest from frame assembly 20. In an embodiment, the maximum cantilevered span beyond the first and second ends of the rail assembly is the same. In an embodiment, the maximum cantilevered span beyond the first and seconds end of the rail assembly is different.

Referring to FIG. 4C, it is preferable to make at least one of wheels 34, 34′ axially movable relative to its shaft 32. This ensures a better alignment between the wheels 34, 34′ and rod 36. Preferably, the center wheel(s) 34′ will be axially movable. Another advantage of providing such adjustability is that, if wheels 34 have grooves 34G for riding on rod 36, the width of grooves 34G can be minimized regardless of the manufacturing tolerances. This in turn may minimize any sideways wobble of table assembly 40 when the table assembly is in a cantilevered position, thus providing a better quality cut.

Referring to FIG. 4D, it is preferable to provide a height differential between bearings 38 to prevent binding during sliding. For example, in a table assembly 40 having four or five bearings 38, the center bearings 38′ may be disposed slightly higher than the rearmost bearings, creating a height differential G1. Similarly, center bearings 38′ may be disposed slightly higher than the end bearings, creating a height differential G2. Preferably, height differentials G1, G2 are substantially equal and are preferably between about 1 mm and about 5 mm.

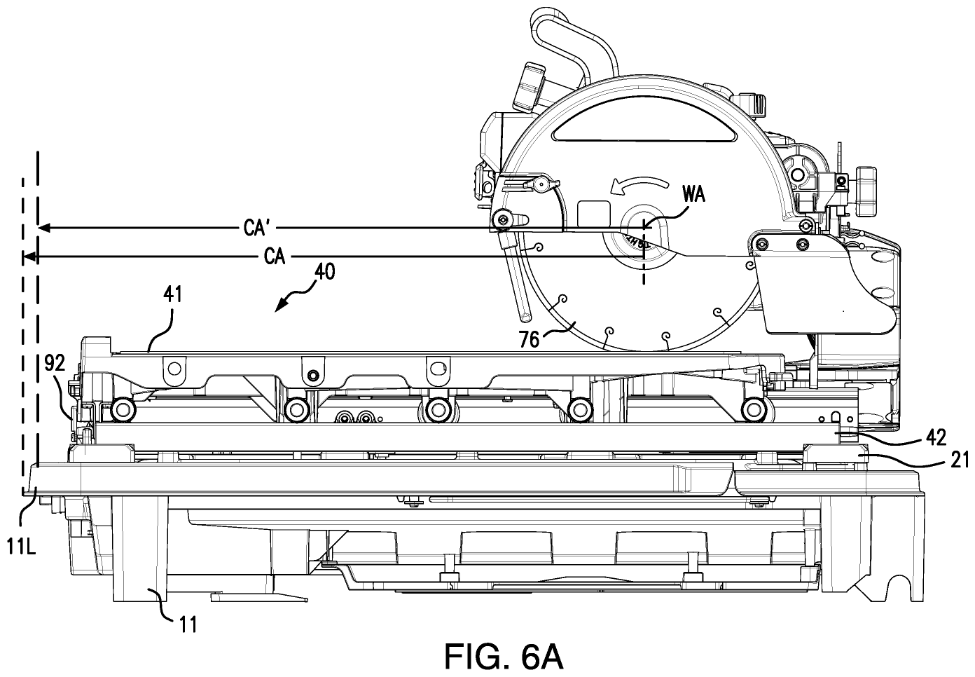

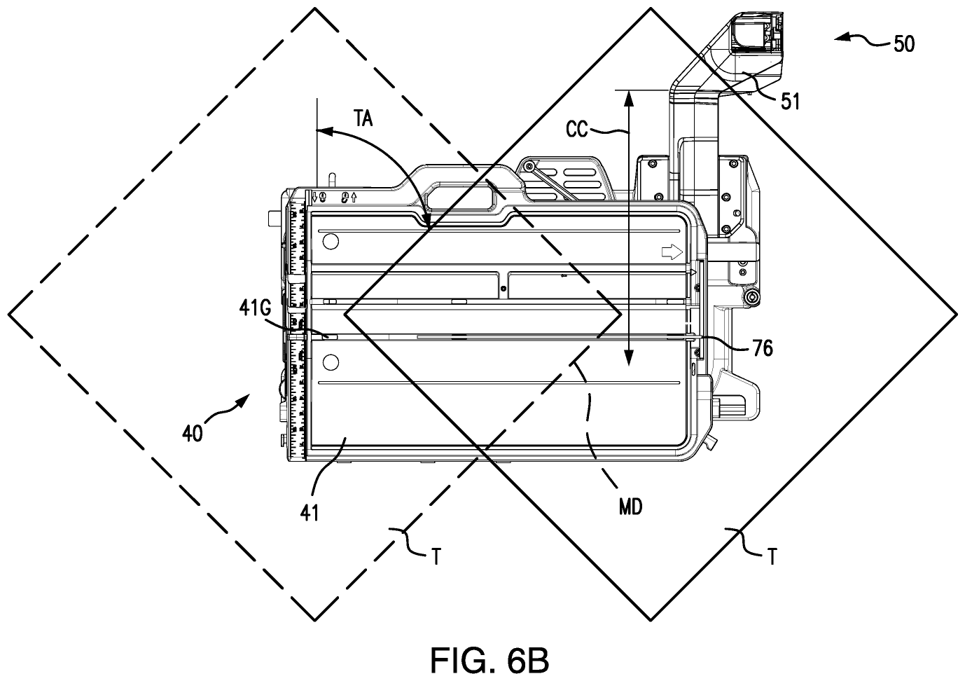

FIG. 4E illustrates table body 41 having an upwardly extending fence 41F for supporting a workpiece, such as the workpiece T shown in FIG. 6B, as table assembly 40 is being moved into and/or cut by cutting wheel 76. Workpiece T can contact an inner wall 41W of fence 41F that faces the top surface of table body 41. Table body 41 may also have at least one groove 41G for receiving cutting wheel 76 during a cutting operation.

Referring to FIGS. 4A and 4E, as table assembly 40 is moved toward cutting wheel 76, cutting wheel 76 cuts a workpiece T disposed on table body 41 and extends below the top surface of table body 41 into one of grooves 41G disposed thereon. In order to avoid cutting wheel 76 cutting into table body 41, it is typical to widen grooves 41G. However, such wider grooves 41G do not indicate to the user where workpiece T will be cut. Accordingly, it is preferable to provide a means to indicate the cutting path of cutting wheel 76 to identify where workpiece T will ultimately be cut.

One such means is shown in FIG. 4E. Basically, a cut indicator in the form of an insert 48 is disposed on fence 41F to cover groove 41G. During manufacture or assembly, table assembly 40 is slid towards cutting wheel 76, until insert 48 is cut by cutting wheel 76. Insert 48 will thus have a cut line CL showing where cutting wheel 76 cuts through. This allows the user to align the workpiece T to cutting wheel 76.

Preferably, insert 48 is made of a material that does not damage cutting wheel 76 or melt upon contact with the cutting wheel. Accordingly, insert 48 may be made of phenolic plastic or any other suitable material, such GE Noryl PPO. It is preferable to design insert 48 so that it can be removed for replacement. Accordingly, insert 48 is preferably attached to fence 41 by screws. In an embodiment, insert 48 has a circular shape.

Table body 41 may have downwardly extending lips 41L, which preferably partially cover first and/or second rails 31, 42. This may limit the amount of fluid and/or slurry that enters first and/or second rails 31, 42.

In an embodiment, table body 41 may be made of cast aluminum. As illustrated in FIG. 4E, table body 41 may have rubber portions 41R overmolded thereon to protect a workpiece placed on table assembly 40. Table assembly 40 may also have a carrying handle 41C extending laterally from a side surface of table body 41.

It is preferable to provide a method for adjusting rail assembly 30 so that table assembly 40 moves in a direction substantially parallel to cutting wheel 76. Referring to FIG. 5, rod 36 is supported by front, middle and rear supports 31FS, 31MS, 31RS, respectively. A fastening member, such as screws 31SSF, 31SSM, 31SSR preferably attach corresponding front, middle and rear supports 31FS, 31MS, 31RS to frame assembly 20. Loosening of the screws allows the angular position of the rod 36 and front support member 31FS to be adjusted. In an embodiment, preferably rear support 31RS (and thus rod 36) can pivot about screw 31SSR, whereas front support 31FS has a slot 31FSS to allow such pivoting action. Screw 31SSR is preferably aligned with the rotating axis WA of cutting wheel 76. Persons skilled in the art will recognize that screw 31SSR may be replaced by a pin, cast boss, etc., so long as rod 36 can be pivoted about one axis, which is aligned with rotating axis WA.

Persons skilled in the art will recognize that this adjustment mechanism may also be used with second rail 42. In addition, persons skilled in the art should recognize that, while only rod 36 is being shown in FIG. 5, the entire first rail 31 is adjustable as it is connected to rod 36.

Referring to FIGS. 6A and 6B, having the ability to move the table assembly 40 into at least one of the first and second cantilevered positions allows for a longer movement range of table assembly 40, which in turn results in an extended cutting capacity without increasing the length of the rail assembly 30 and/or base 11. For example, the tile saw shown in FIGS. 6A and 6B may have a cutting wheel 76 with a diameter of about 10 inches, a distance CA between the wheel axis WA and the front of base 11 of about 60.56 centimeters (or a distance CA′ between the wheel axis WA and the front of base 11, including lip 11L, of about 62.18 centimeters), and a distance CC between the column body 51 and the plane containing cutting wheel 76 of about 18 inches (45.72 centimeters), may cut a workpiece T about 34, 35, 36, or 37 inches (between 86 and 94 centimeters) long disposed on table body 41 at a workpiece angle TA of 0° in one pass. The same tile saw could also cut a square workpiece T having sides of about 25 inches (63.5 centimeters) along its major diagonal MD (i.e., workpiece T being disposed at a workpiece angle TA of 45°) in one pass. The same tile saw could also cut a square workpiece T having sides of about 36 inches (91.44 centimeters) along its major diagonal MD (i.e., workpiece T being disposed at a workpiece angle TA of 45°) in two passes. The relative distances between the wheels 34, 34′ the motor assembly 70 and the rail assembly 30 allow the saw to maintain the top surface of the table body 41 in a position parallel and/or substantially parallel to the rail assembly while in the cantilevered position. FIGS. 7A and 7B illustrate the relationships between the wheels 34, 34′ and the motor assembly. In an embodiment, the distance between the end wheels 34 and the middle wheels 34′ is greater than the distance between adjacent middle wheels 34′. For example, the distance between each end wheel 34 and the adjacent middle wheel 34′ is greater than the distance between adjacent middle wheels 34′. In another embodiment, the distances between wheels 34, 34′ can be equal.

FIGS. 7A and 7B further illustrate exemplary cantilevering positions of the table assembly. For example, in FIGS. 7A and 7B, a leading end portion of the table assembly 40 is positioned at a maximum distance away from the motor or at the maximum cantilevered span with respect to the frame 21. FIG. 7A illustrates a first cantilevered position in which the table assembly 40 is positioned at the maximum cantilevered span with respect to the frame 21. In this position, at least two of the plurality of wheels, for example, first end wheel 34 and an adjacent middle wheel 34′ are moved beyond the first end 30A of the rail assembly 30. In the first cantilevered position, the distance D_{F} between a cutting wheel axis plane P_{CW} and a first end wheel axis W₁ that lies in a first end wheel axis plane P_{W1} farthest from the motor, is greater than the length L_{R} of first rail 31. Also, in the maximum cantilevered span position of FIG. 7A, a ratio of the distance D_{F} between the cutting wheel axis plane P_{CW} and first end wheel axis plane P_{W1} to the length L_{R} of the rail is greater than 1.0, for example, 1.2 or 1.25.

In the second cantilevered position, as shown in FIG. 7B, at least two of the plurality of wheels, for example, second end wheel 34 and middle wheels 34′, 34′ are moved beyond the second end 30B of rail assembly 30. In this position, in which table assembly 40 is cantilevered to a maximum cantilevered span at the second end 30B of the rail assembly, the distance Ds between the cutting wheel axis plane P_{CW} and the second end wheel axis plane P_{W2} is less than the length L_{R} of the first rail 31 and/or second rail 42. Additionally, a ratio of the distance Ds between the second end wheel axis P_{W2} and the first end wheel axis P_{W1} to the length of the rail L_{R} is at least 0.6 or more, including 0.7, 0.8 and 0.85.

In an embodiment, the length of the table assembly 40 is greater than the distance DR between the cutting wheel axis plane P_{CW} and a plane P_{R1}, P_{R2} defining a longitudinal end of the rail 31, 42.

In an embodiment, the travel length of table assembly 40 along rail assembly 30 is greater than about 1.0 or greater, such as, for example 1.2 times the length of the rails 31, 42. In an embodiment, the length of table assembly 40 is substantially equal to the length L_{R} of the rail.

In an embodiment of the first and second cantilevered positions shown in FIGS. 7A and 7B, more than 50% of the table assembly is movable beyond the first end 30A of rail assembly 30 and the second end 30B of the rail assembly. As such, a cantilevered portion of the table assembly can be about 50% of the table length. In an embodiment a cantilevered portion of the table can be about 70% of the table length.

In an embodiment of the first cantilevered position shown in FIG. 7A, more than 75% of the table assembly is movable beyond the first end 30A of the rail assembly 30 and the second end 30B of the rail assembly. As such, a cantilevered portion of table assembly 40 can be about 70% or more than 75% of the table length.

Additionally, a ratio of the distance D_{W} between the first end wheel axis plane P_{W1} and the second end wheel axis plane P_{W2} to the length of the rail L_{R} is less that 0.85. Also, the distance D_{W} between the first end wheel axis plane P_{W1} and the second end wheel axis plane P_{W2} also represents, substantially, the length of the table assembly 40. In an embodiment wherein the inner surface of fence 41F is on the same plane as the first end wheel axis W₁, a distance between the cutting wheel axis WA and the first end wheel axis P_{W1} or the inner surface of fence 41F at the maximum cantilevered span position is at least 36 inches. In another embodiment wherein the inner surface of fence 41F is in a different plane from the first end wheel axis W₁, a distance between the cutting wheel axis WA and the first end wheel axis P_{W1} at the maximum cantilevered span position is at least 36 inches. A ratio of the distance D between the inner surface of fence 41F at the maximum cantilevered span position at the first end 30A of the rail assembly 30 and the second end wheel axis plane P_{W2} at the maximum cantilevered span position at the second end of rail assembly 30, to the rail length L_{R} is greater than 1.5 or greater than 1.75 or greater than 2.0. A ratio between a cutting wheel diameter and an oblique tile distance is in a range of about 0.19 to about 0.28. The oblique tile distance is the measurement from the inner surface of the fence 41F to the contact edge of the cutting wheel 76.

The plurality of second rail bearings 46 serially arranged on an underside of table body 41 support table assembly 40 as it moves along second 42 rail. In the first cantilevered position of the table assembly, at least two bearings 38, 46 one on each lateral side of table body 41 are moved beyond the first end of first 31 and second 42 rails of rail assembly 30. In a second cantilevered position of the table assembly, at least two bearings 38, 46 on each lateral side of table body 41, are moved beyond the second end of the first 31 and second 42 rail assemblies. In an embodiment, rail bearings can be arranged on other portions of the table body including side portions.

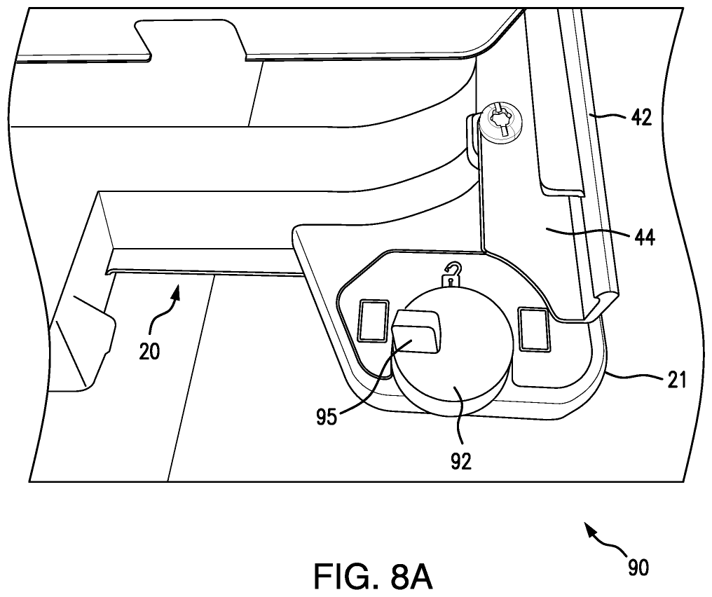

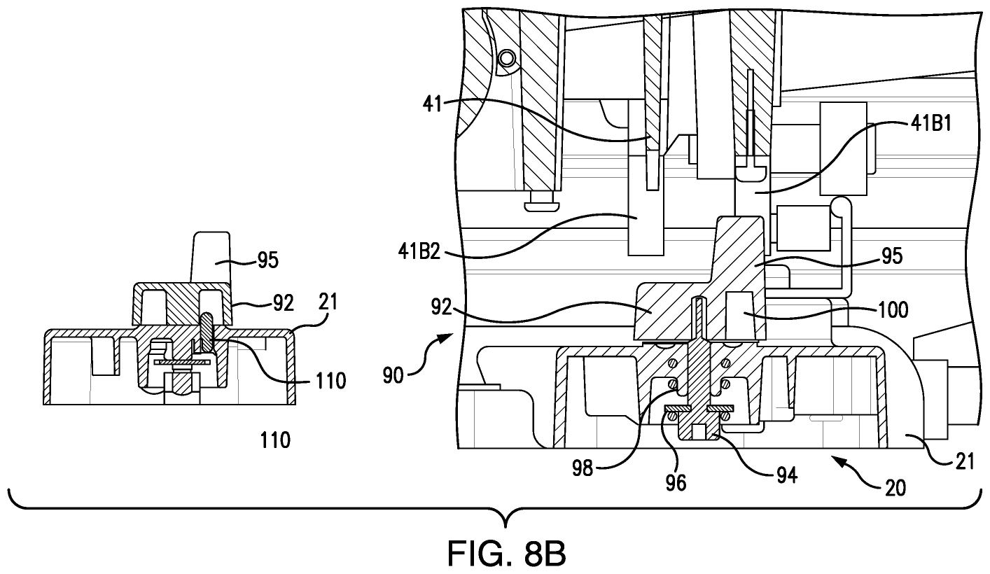

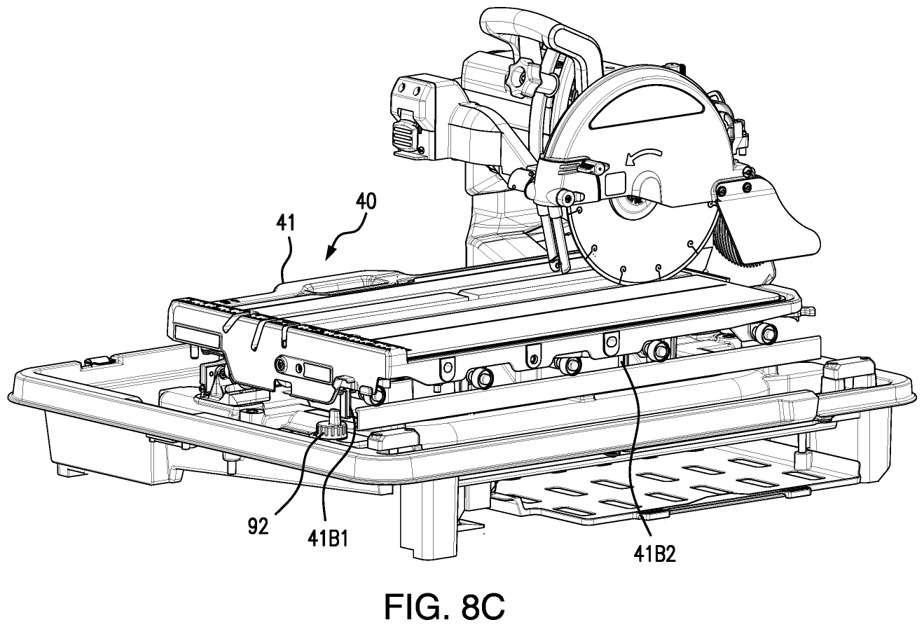

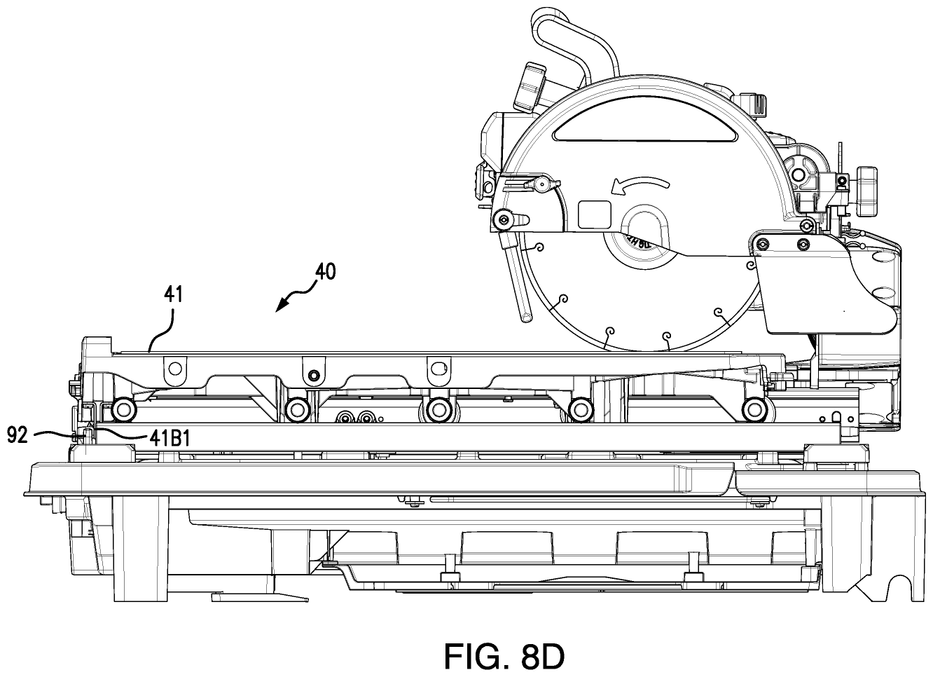

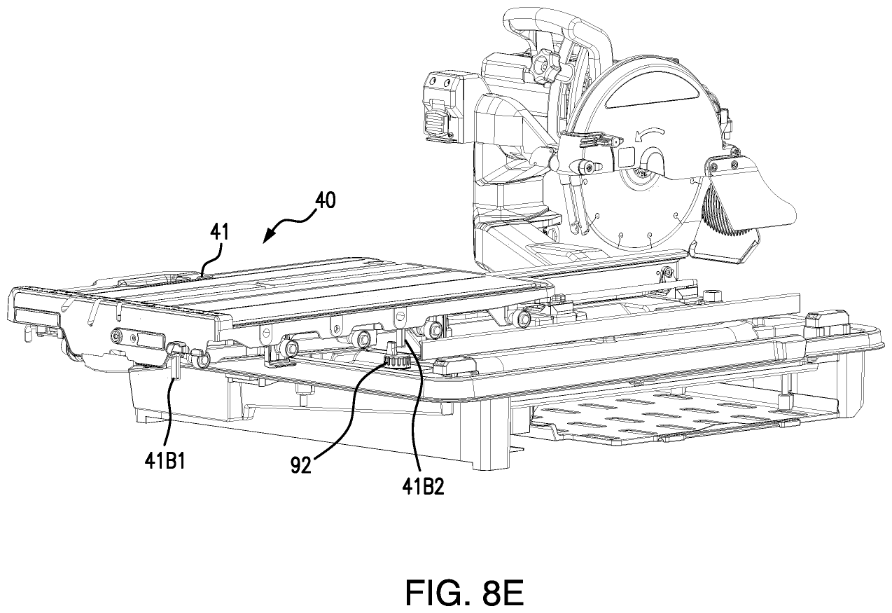

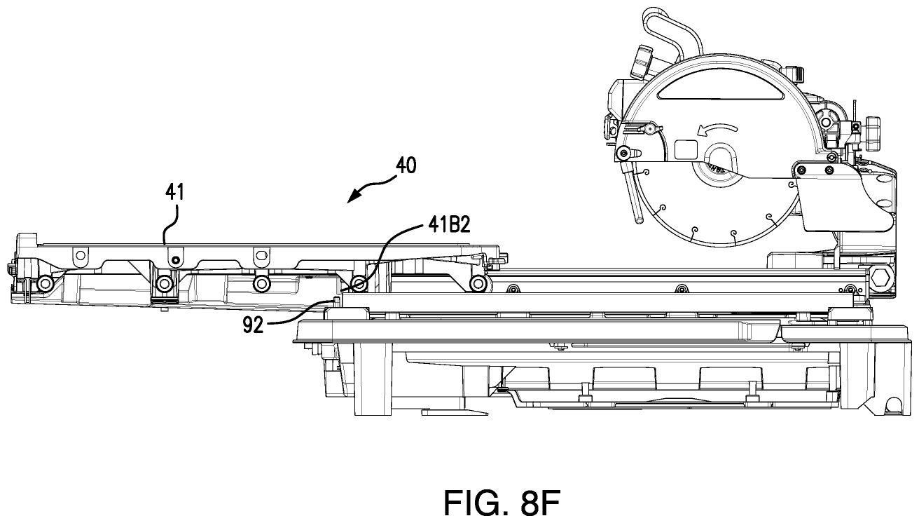

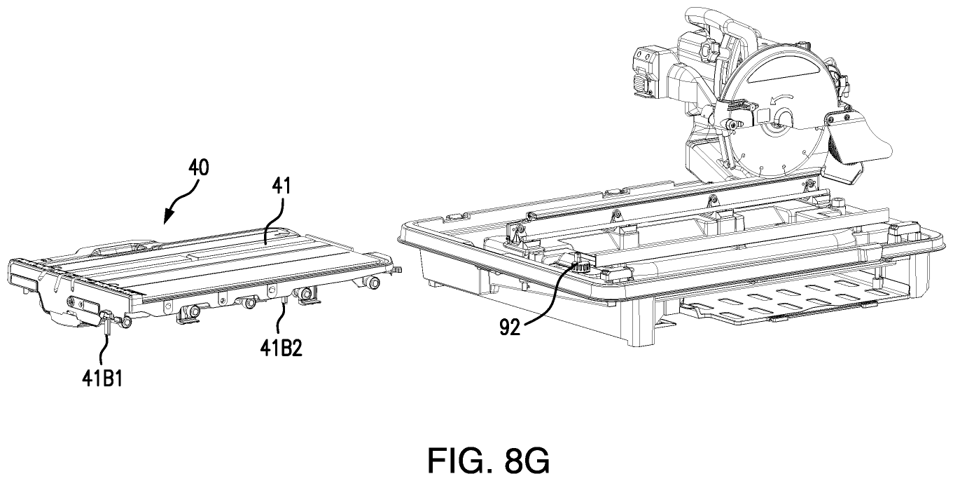

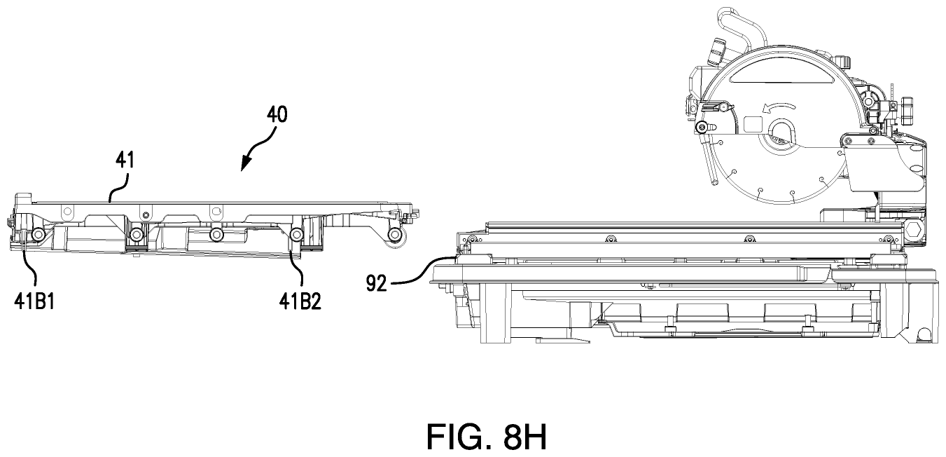

Persons skilled in the art should also recognize table assembly 40 can only be inserted into and/or removed from rail assembly 30 by moving table assembly in a direction parallel to the longitudinal axes of first and second rails 31, 42. It may be desirable to provide first rail 31 and second rail 42 with openings, such as for example, opening 44 in FIG. 8A, on their respective upper portions to allow the user to lift off table assembly 40 when bearings 38, 46 are aligned with said openings. Persons skilled in the art will recognize that multiple sets of openings 44 can be provided on first portion 31C of first rail 31 and on second rail 42 so that the user can lift off table assembly 40 at multiple locations.

Referring to FIGS. 8A-8H, the tile saw assembly 10 includes a table positioning knob assembly 90. The table positioning knob assembly 90 controls the extent to which the table assembly 40 moves along the first 31 and second 42 rails of the rail assembly 30 and how the table assembly can be removed from the rail assembly. As shown in FIG. 8A-8B, the table positioning knob assembly 90 is disposed on the frame 21. The table positioning knob assembly 90 includes a knob body 92 that has a projecting member 95 on a top surface that engages brackets extending downwardly, toward the frame 21 from the bottom surface of the table. Different positions of the knob 92 cause the projecting member 95 to engage different brackets that either allow the table assembly to remain or be removed from the rails.

The knob body is rotatable about a knob shaft, such as bolt 94 that passes through the frame 21. In an embodiment, the knob body 92 can be slidable or rotatable about a fixed point. The bolt 94 is threadedly mounted to the frame 21 and held in place by a washer 96. The knob body 92 is biased toward the frame 21 by a spring 98.

The knob body 92 is rotatable and releasable about the bolt 94 to a predetermined position with respect to a positioning element 102 mounted on or integral with the frame 21. The positioning element 102 has a top surface that faces the bottom surface of the knob body 92. The bolt 94 passes through the center of the positioning element 102 and the center of the knob body 92 and coaxially connects the knob body to the positioning element. A stop member, such as pin 110, and a plurality of detent grooves 112 are disposed on the top surface of the positioning element and circumscribe the bolt 94. Each detent groove 112 represents a different position of the knob body. The knob body 92 includes a spring-biased detent ball 114 that extends through the bottom surface and engages detent grooves 112 in positioning element 102 to temporarily fix the knob body with respect to the positioning element. Added force against projecting member 95 on the top surface of the knob overcomes the bias of the detent ball 114 to move the detent ball 114 out of a respective detent groove 112. A cavity 100 in knob body 92 receives pin 110, which can abut ribs 116 on the bottom surface of the knob body to thereby stop the knob body 92 from rotating.

The knob body 92 is configured to engage with the table assembly 40. In an embodiment, the table body 41 of the table assembly includes a plurality of brackets 41B1, 41B2 on the underside thereof. The brackets 41B1, 41B2 extend or depend from a bottom surface of the table body 41 toward at least one of the first and second rails 31, 42. The brackets are arranged along the longitudinal length of the table and are laterally arranged or offset from each other. In certain positions of the table positioning knob 90, engagement with the table brackets 41B1, 41B2 will either fully or partially position the table assembly 40 on the rails 31, 42, or allow the table assembly 40 to be removed completely from the rails. Although the brackets illustrated as extending downwardly, from the bottom surface of the table, there can be other locations and arrangements for the brackets and knob. For example, the knob can be located on the bottom surface of the table so that the projecting member on the knob extends downwardly, and the bracket can extend upwardly from an upper surface of the frame.

FIGS. 8C and 8D illustrate a first position of the table positioning knob 90 in which projecting member 95 of knob body 92 is positioned for engagement with bracket 41B1 so that the table assembly movement is limited to a position over or within the envelope of base 11. In the first position, the bracket 41B1 contacts projecting member 95 preventing the table from moving further along rail assembly 30 in the direction of the first end 30A.

FIGS. 8E and 8F illustrate a second position of table positioning knob 90 in which projecting member 95 of knob body 92 is positioned for engagement with bracket 41B2. In this arrangement, the knob 90 is moved, such as by rotation, to a second position so that first bracket 41B1 bypasses projecting member 95, but second bracket 41B2 engages the projecting member. Since second bracket 41B2 is longitudinally rearward of and offset from first bracket 41B1, the table assembly can reach a cantilevered position before the bracket 41B2 engages the projecting member 95. As a result, a portion of the table assembly 40 extends beyond the base 11 and frame assembly 20 and can be retained in this position without further forward movement, by the engagement of the projecting member 95 and the second bracket 41B2.

FIGS. 8G and 8H illustrate a position of the knob body 92 in which both first and second brackets 41B1, 41B2 do not engage the projecting member 95. In this arrangement, knob 90 is moved, such as by rotation, to a third position so that first and second brackets 41B1 bypass projecting member 95 as the table assembly moves along the rail assembly 30. As a result of both brackets bypassing projecting member 95, the table assembly 40 can be removed completely from the rails. Although two brackets are illustrated, any number of brackets, including one, three, four or more can be employed to limit movement of the table assembly at different positions along the saw.

As shown in FIG. 8I, when the knob body 92 is released, the knob body is biased by the spring 98 toward the frame and held in position by an arrangement of ribs 116 and a pin 110 prevent the knob from rotating while the knob is biased toward the frame 21.

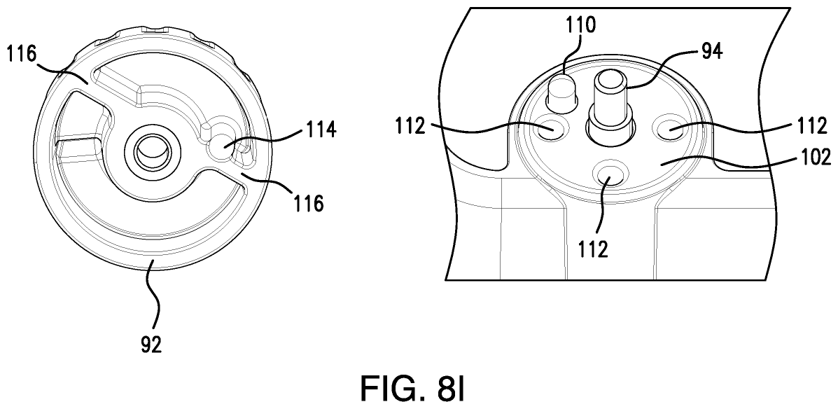

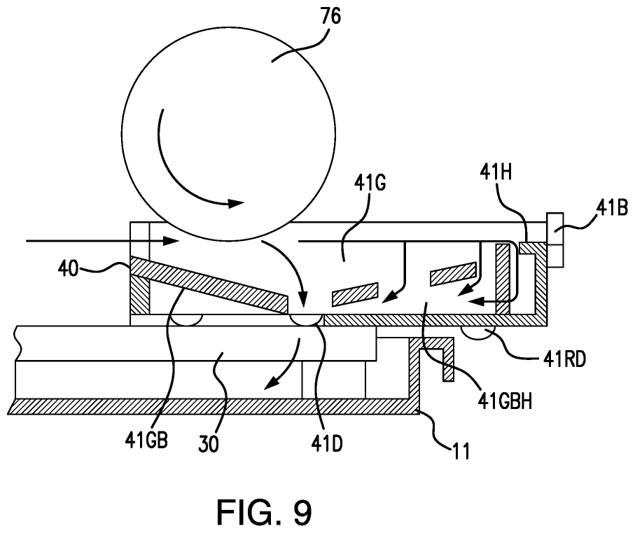

As mentioned above, table body 41 preferably has grooves 41G. Referring to FIG. 9, grooves 41G may have a bottom wall 41GB, which slopes downwardly from the front and rear ends of table body 41 to the center of table body 41. Fluid and/or slurry generated during the cutting operation may exit table body 41 through a drain hole 41D provided at the center of bottom wall 41GB. It is preferable to provide drain hole 41D near the center of table body 41 so that drain hole 41D can drain into base 11 regardless of whether table body 41 is within the envelope of base 11 or whether table body 41 is in the front and/or rear cantilevered positions.

Alternatively, fluid and/or slurry generated during the cutting operation may exit table body 41 through holes 41GBH, which in turn may drain into a draining pan 41RD. Draining pan 41RD preferably has a bottom wall which slopes downwardly from the rear end of table body 41 towards the drain hole 41D. The fluid and/or slurry exiting through drain hole 41D ends up in base 11.

Draining pan 41RD may also have a substantially horizontal baffle 41H disposed below the top surface of table body 41 and cutting wheel 76. Baffle 41H would catch some of the fluid and/or slurry that is thrown rearwardly due to the rotation of the cutting wheel 76 and redirect such fluid and/or slurry into the draining pan 41RD.

Table body 41 may also have a brush 41B at the rearward and/or forward ends of grooves 41G to help limit the flow of fluid and/or slurry beyond the brush 41B and/or grooves 41G. Preferably, the brush 41B has bristles made of nylon or a synthetic rubber-like material.

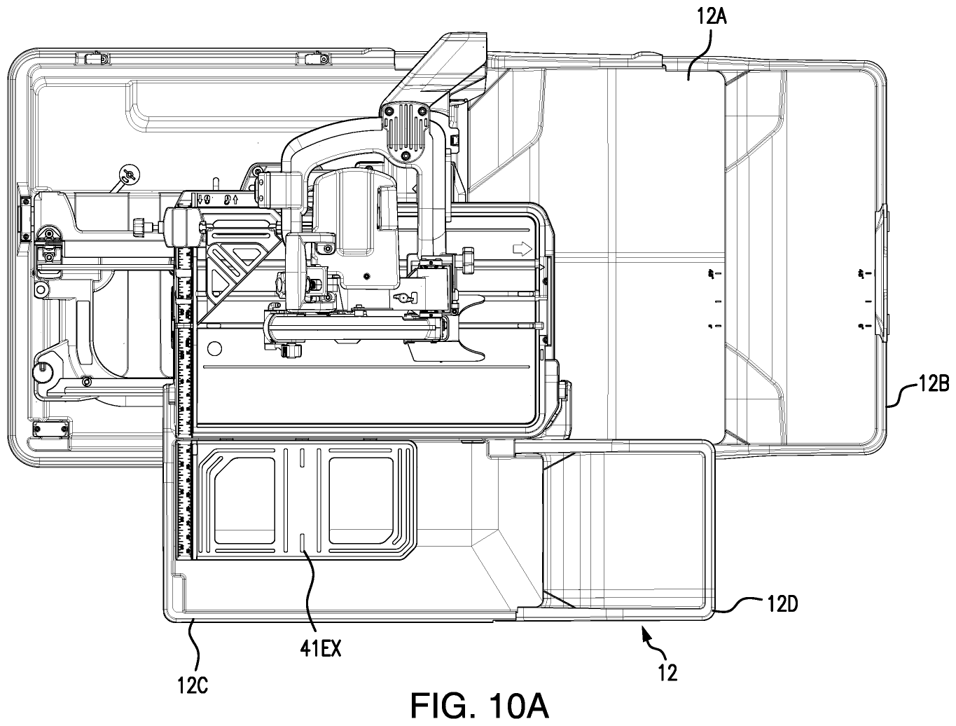

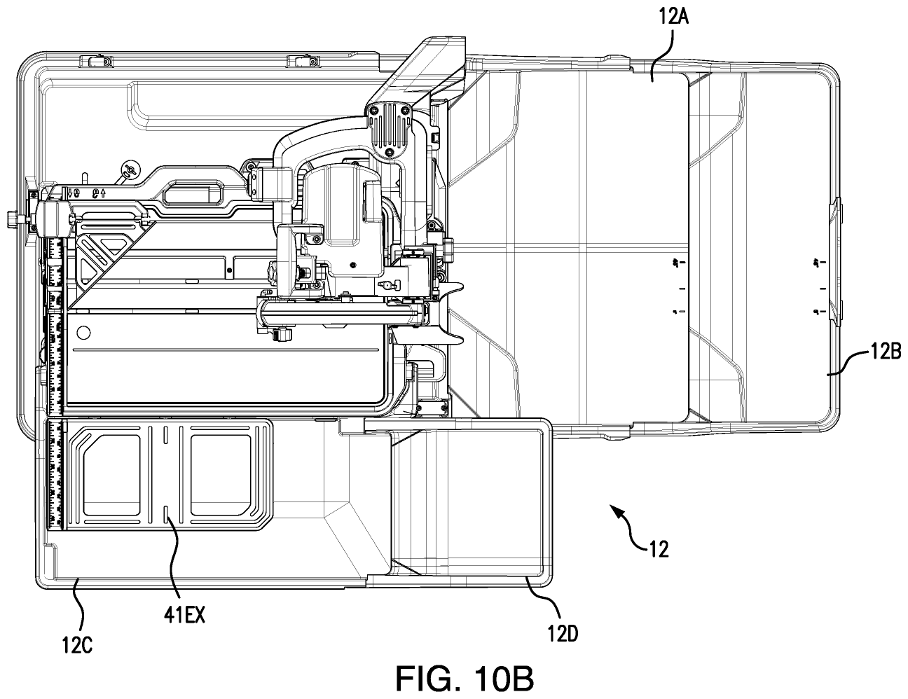

Referring to FIG. 10A, to maximize the amount of water and slurry received by base 11, it may be preferable to extend base 11 by providing extension pans. Extension pan assembly 12 can further assist in redirecting fluid and/or slurry generated during the cutting operation into base 11. In particular, extension pan assembly 12 can be attached to table body 41 by slide fitting. The extension pan assembly 12 can include first 12A, second 12B, third 12C and fourth 12D extension pans, for example. The first extension pan 12A is shown as connected to the base 11 and extends outwardly from the base in the longitudinal direction. The first extension pan 12A can be arranged at an acute angle with respect to the base 11 in order to redirect the water and slurry toward the tub portion of the base. The second extension pan 12B is connected to the first extension pan 12B and projects farther away from the base 11 than the first extension pan, thereby providing a greater surface area than just the base and the first extension pan for collecting water and slurry. The second extension pan 12B can be snap-fit onto the first extension pan 12B by corresponding attachment surfaces that can be located on the sides of the first extension pan. The connected first and second extension pans 12A, 12B provide a continuous surface for the receipt and redirection of the water and slurry. In an embodiment, the base 11 may have a lip 11L. The first extension pan 12A of the extension pan assembly 12 may be shaped so that it is placed on or snapped onto the lip 11L.

The extension pan assembly 12 can also be fitted with a splash guard 14. The splash guard 14 can prevent water and slurry from splashing beyond the extension pan assembly. In an embodiment shown in FIGS. 1A, 1B and 2, the splash guard is fitted on the second extension pan 12B and positioned longitudinally opposite to the cutting wheel 76. The splash guard 14 can be removably attached to the extension pan assembly 12, such as by a snap fit assembly. The third extension pan 12C can be attached to a side of the table body 41. Extension pan 12C preferably has a bottom wall which preferably extends downwardly from its outermost edge towards table body 41. The fourth extension pan 12D can be attached to the third extension pan 12C and/or the table body 41.

Persons skilled in the art will recognize that other extension pans may also be attached to any sides or the front of base 11. These extension pans are preferably blow molded, injection molded or vacuum formed and made of ABS, styrene, polypropylene, or HDPE.

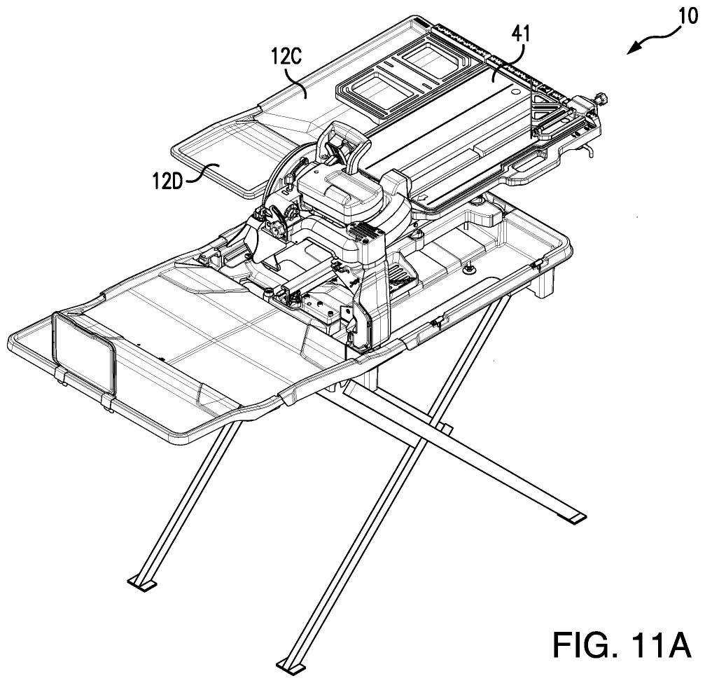

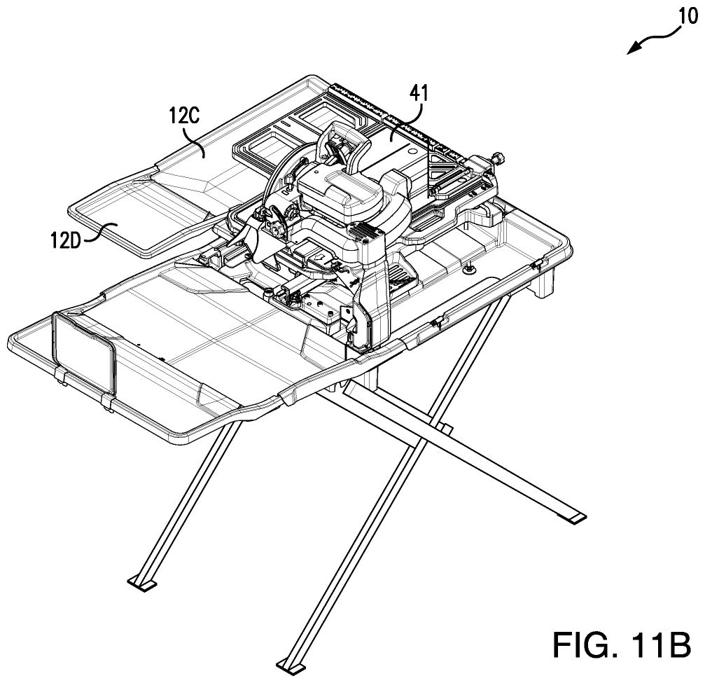

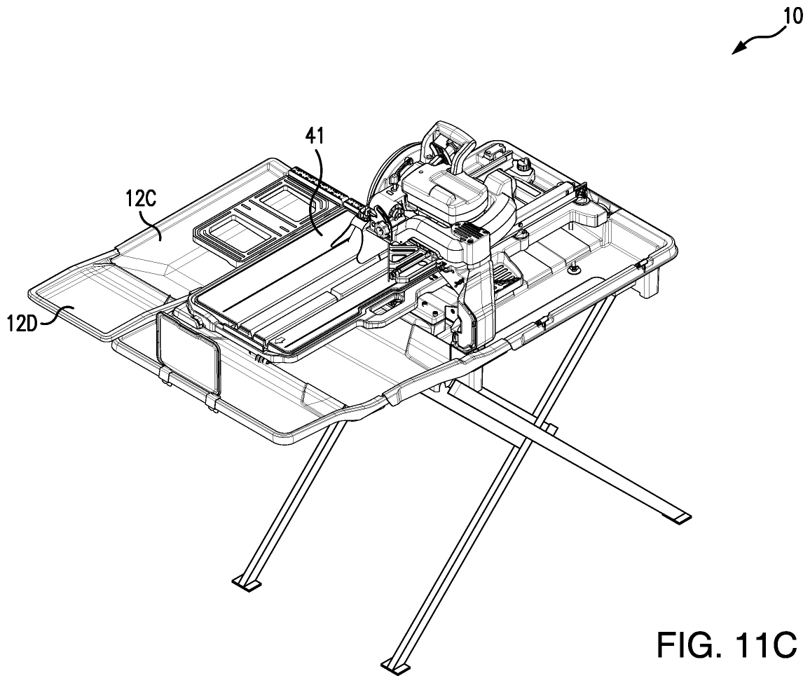

FIGS. 11A-11C illustrate the movement of the table assembly 40 along the rail assembly 30, and the portion of the extension pan assembly 12 that travels with the table assembly. As shown, extension pans 12C and 12D are connected to the table body by slide fitting and move with the table assembly when the table assembly is moved to the first and second cantilevering positions.

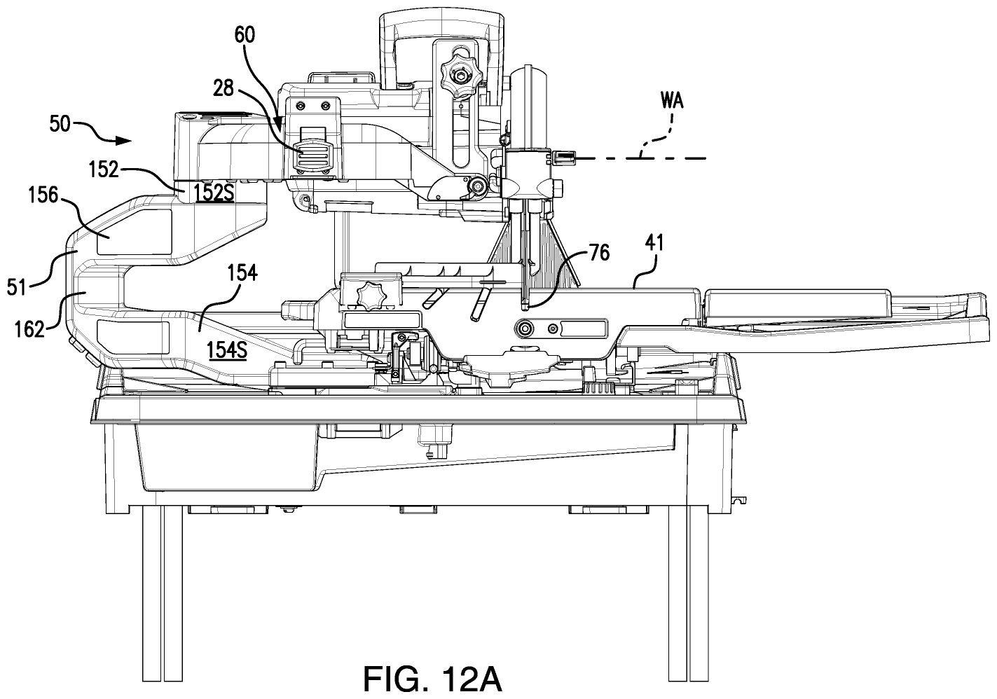

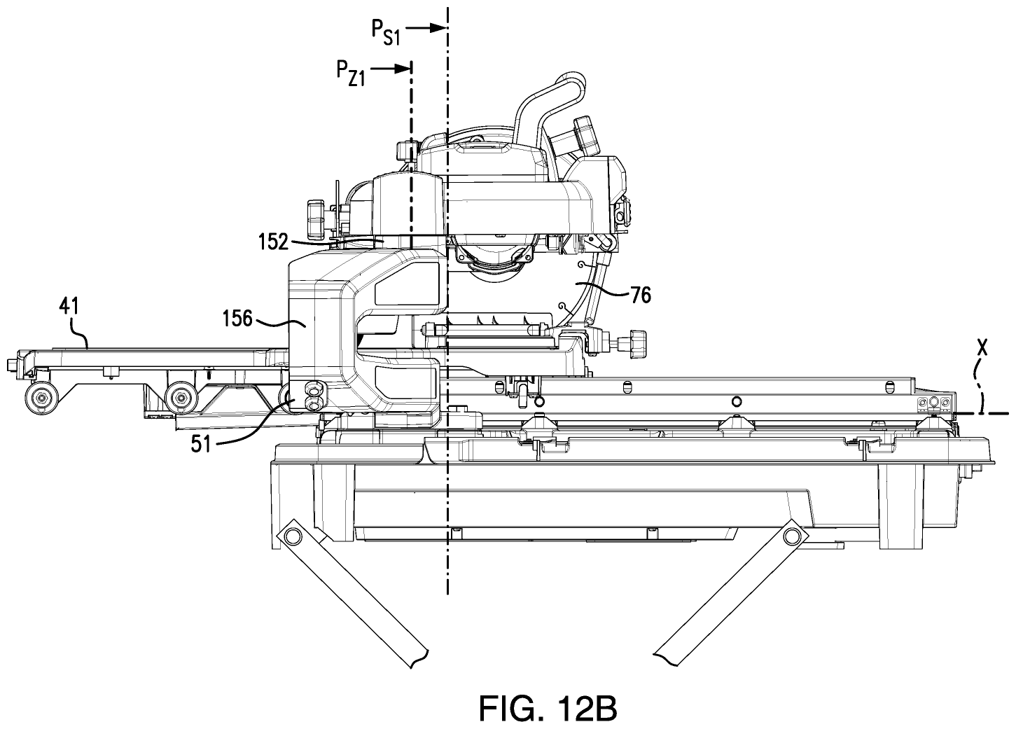

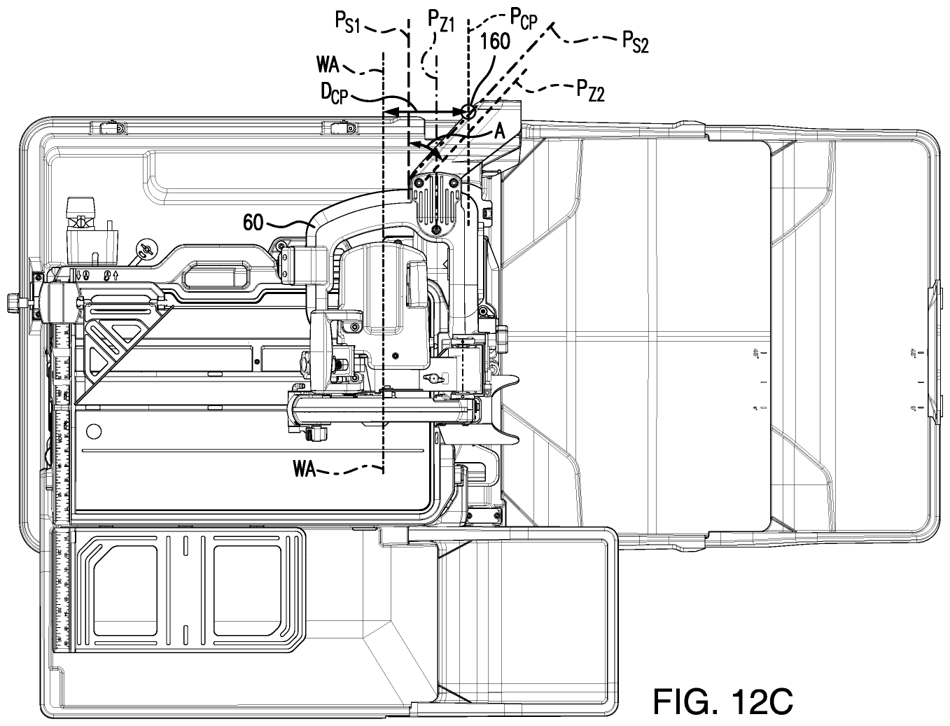

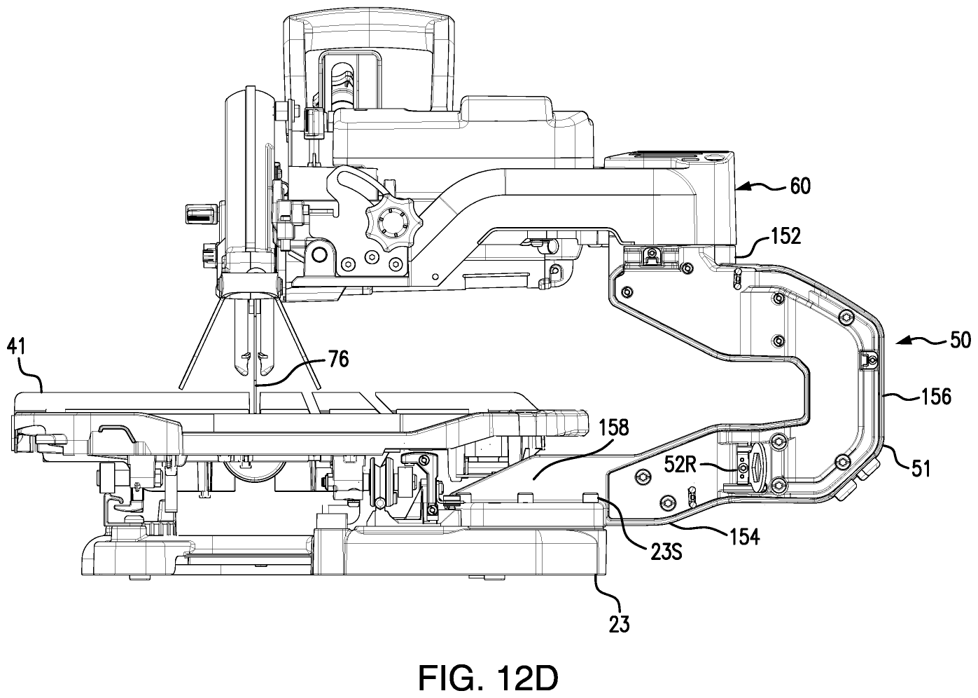

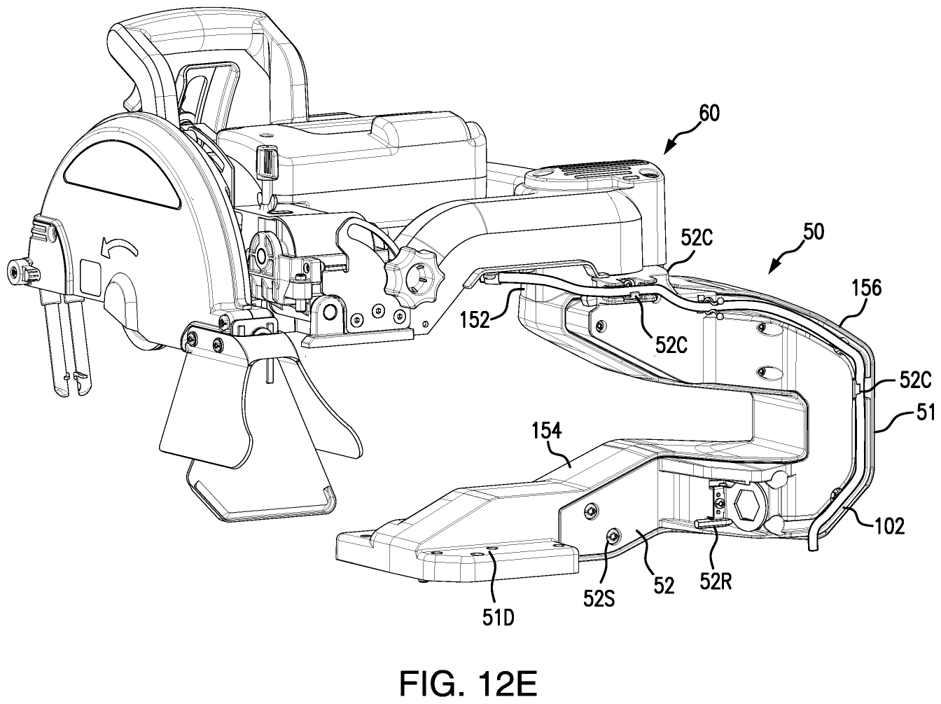

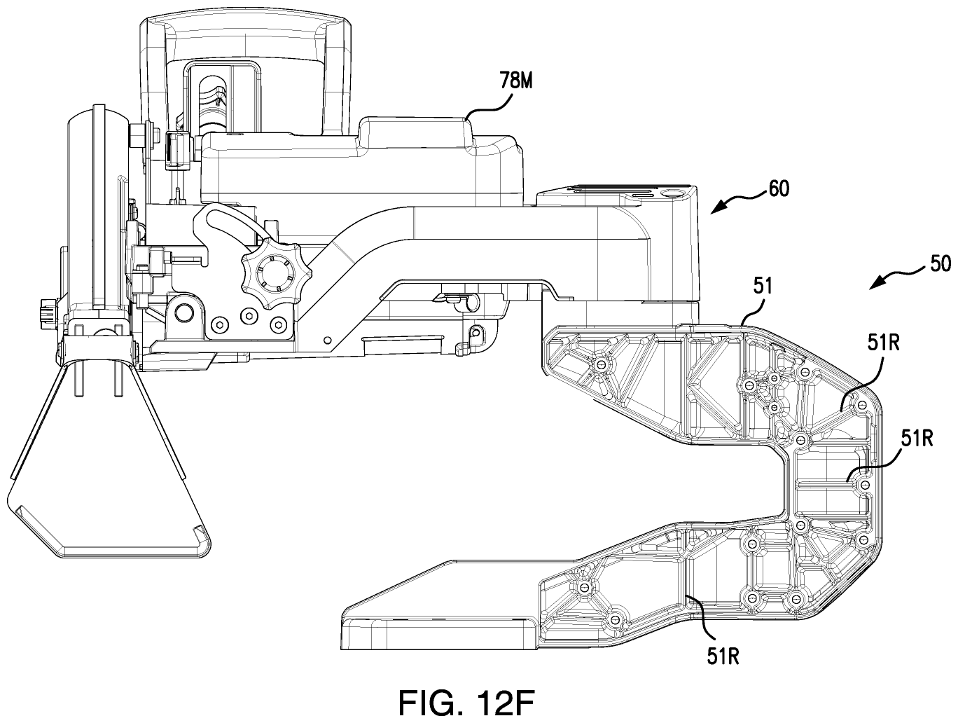

Referring to FIGS. 12A-12F, column assembly 50 may be supported by frame assembly 20. Column assembly 50 in turn may support arm assembly 60.

The column assembly 50 can have an inner column portion and an outer column portion. In particular, the column assembly can have a be substantially C-shaped body 51 having two oppositely disposed connecting end portions defining the inner column portion, and a central portion therebetween defining an outer column portion. The C-shape refers to a body that generally has the appearance of the letter C.

The oppositely disposed connecting end portions of the column body 51 include a first connecting end portion 152 and a second connecting end portion 154. The first connecting end portion 152 connects the column assembly 50 to the arm assembly 60. The second connecting end portion 154 connects the column assembly 50 to at least one of the base 11 and the frame assembly 20. The central portion 156 extends outwardly from the connecting end portions 152, 154 in a direction away from the rail assembly. Therefore, the connecting end portions are disposed in a space between the central portion and the rail assembly 30. The central portion 156 being farther away from the rail assembly 30 that the connecting end portions 152, 154 provides a space for larger tiles on the saw assembly, the space being wider than the space provided by the width of the table body 41.

Generally the central portion 156 is obliquely angled with respect to the connecting end portions 152, 154 giving the column assembly an asymmetrical C-shape. In particular, the central portion 156 is disposed in a different plane from the first and second connecting end portions 152, 154. As shown in FIG. 12C, the central portion 156 is obliquely angled rearward or in the direction of the second end 30B of the rail assembly. As shown in FIG. 12B, the first and second connecting end portions 152, 154 define a connecting end plane P_{Z1} passing through the connecting portions end, in a vertical direction, and perpendicular to the longitudinal axis X. The vertical direction is defined in relation to an axis Z being oriented vertically, such as from the bottom of the tile saw upwards in FIGS. 12A, 12B and 12D. The central portion 156 defines a central portion plane P_{Z2} passing through the central portion in a vertical direction. The central portion plane forms an oblique angle with the connecting end plane P_{Z1} and also with the longitudinal axis X. In an embodiment, as viewed in the plan view of FIG. 12C, the central portion plane P_{Z2} forms an acute angle A with the connecting end plane P_{Z1}. In this position, the saw assembly is able to cross-cut wide tile, such as tile having a width of 5 inches, 6 inches, 8 inches and 8.5 inches.

Additionally, in an embodiment, as shown in FIGS. A and 12B, the first and second connecting end portions 152, 154 of the body 51 have a connecting end portion surfaces 152S, 154S that lie in a first surface plane Psi, perpendicular to the longitudinal axis X of and facing first end 30A of rail assembly 30. The central portion 156 also has a central portion surface 156S contiguous with the connecting end portion surfaces 152S, 154S, that lies in the second surface plane P_{S2}. The second surface plane P_{S2} forms an non-coplanar surface or oblique angle with the first surface plane Psi. As such, the central portion surface 156S is obliquely angled with respect to the connecting end surfaces 152, 154. The obliquely positioned central portion 156 places the weight of the column assembly in proximity to the center of the cutting wheel to maintain balance of the tile saw, while expanding the cutting capacity rearward.

In the embodiments of FIGS. 12A and 12C, an angle A between the connecting end portion plane P_{Z1} and the central portion plane P_{Z2}, and first and second planes P_{S1} and P_{S2} is less than 90°. In an embodiment, the angle A can be in a range of from 1° to 90°, for example, 20°, 30°, 45°, 60° or 75°, up to 90°.

The central portion includes a flared open end through which a workpiece can pass during a cutting operation, and a closed end 162 having a planar surface. The closed end 162 provides a stop surface that can stop a large workpiece from moving closer to the cutting wheel 76. The guide surface includes a plurality of contact points, including a forward contact point 160 disposed at the intersection of the closed end 162 surface and the central portion surface plane PS2. The forward contact point 160 lies in a contact point plane PCP perpendicular to the longitudinal axis X of the rail assembly. In an embodiment, the distance D_{CP} between the forward contact point 160 and the cutting wheel axis WA is at least 2 inches or at least 4 inches, or at least 6 inches.

In an embodiment, the second connecting end portion 154 can be longer than the first connecting end portion 152 and include a bracket that attaches the column assembly 50 to the support pad 23 of the frame assembly 20. The second connecting end portion 154 has a distal end 158 that is tapered toward the table assembly 40. The tapered or reduced height of the second connecting end 154 allows the second connecting end 154 to extend underneath the table body 41 and provide additional stability to the column assembly 50 on the frame 21 or the base 11.

Column body 51 is preferably hollow and made of cast aluminum. Internal support ribs 51R may be disposed within column body 51 to increase its strength.

It is preferable to route all the electrical wires (not shown) that provide power to the motor 78M through column body 51 and arm assembly 60. A cover member, such as plate 52, may be used to cover and/or seal the inner cavity of column body 51 that contains the electrical wires. Plate 52 may also support the incoming power cable (not shown), which may then extend through the inner cavity of column body 51 and into the arm assembly 60. In an embodiment, the plate 52 can include a channel formed therein for guiding the power cable from the tool to an electrical outlet. In addition, plate 52 may also support a second power cable (not shown), which can be used to power any other electrical device, such as pump 16. Plate 52 may be affixed to column body by screws 52S.

Additionally, clips 52C may be disposed about the plate 52 to secure and provide a guide for the hose 102 from a nozzle assembly or fluid delivery system 100 to the pump 16. In an embodiment, the clips 52C can be formed from plastic. Further the plate 52 can have recesses that are sized and shaped to store additional tools and components of the tile saw. For example, the plate can include recesses 52R for removably securing at least one Allen wrench and blade wrench for fixing the cutting wheel 76 to the motor assembly 70.

Referring to FIGS. 1A, 1B, 2, 13A, 13B and 13C, arm assembly 60 preferably has a body 61 which is substantially U-shaped. Preferably arm body 61 is substantially hollow to allow the electrical wires (not shown) to extend therethrough. Arm body 61 may pivotably support motor assembly 70. Preferably, arm body 61 supports motor assembly 70 at both ends thereof.

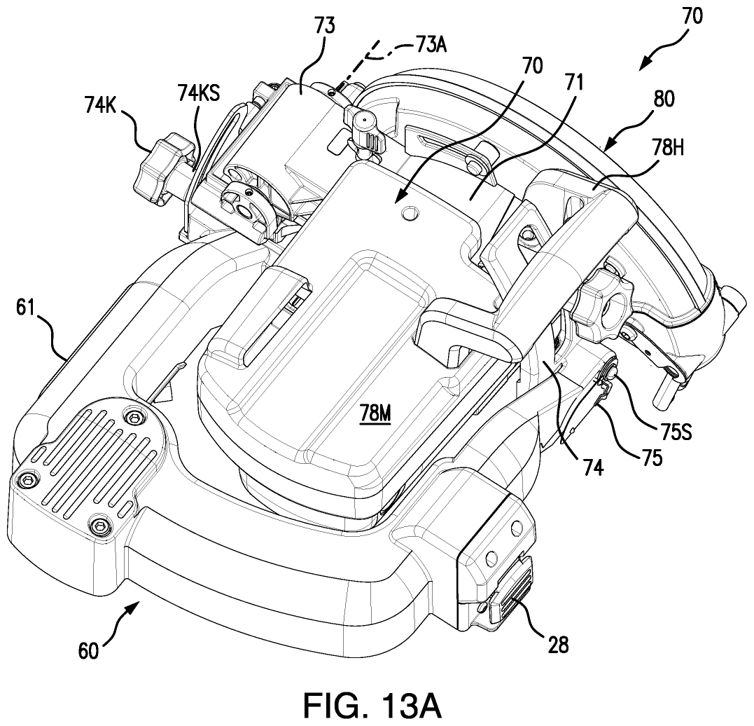

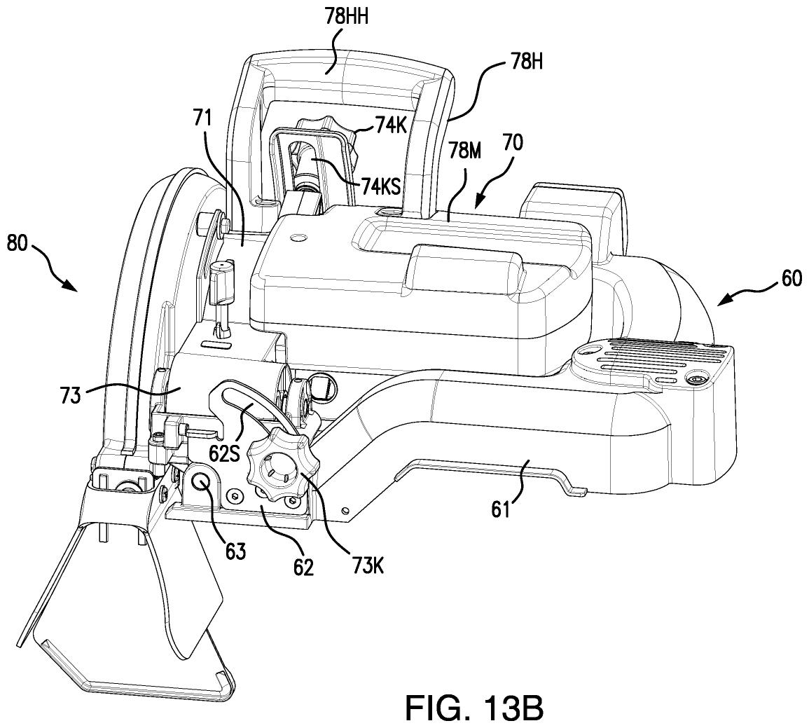

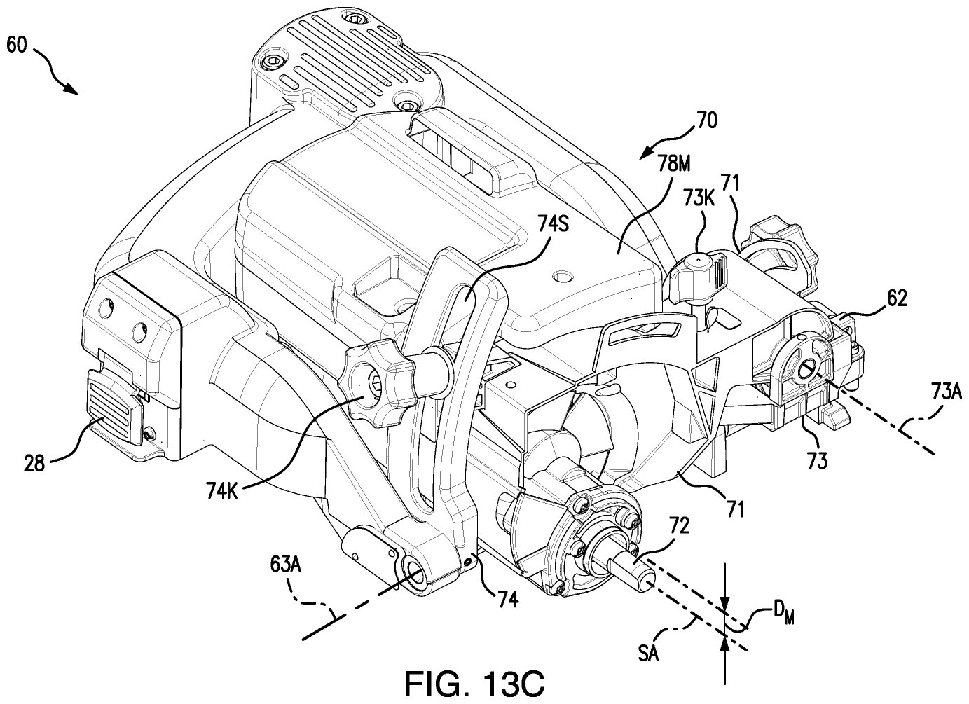

Motor assembly 70 preferably includes a housing 78 covering motor 78M. Housing 78 may be attached to a pivot arm 71. Motor 78M preferably drives a shaft 72, which carries a cutting wheel 76. The shaft 72 rotates about motor shaft axis SA (FIG. 13C). Cutting wheel 76 may be partially covered by guard assembly 80, as described more fully below.

Referring to FIGS. 1A, 1B, 2 and 13C, the motor shaft axis SA lies in a plane perpendicular to the top surface of the table body. Movement of the motor toward the table assembly, or during shaft contact with the workpiece, the motor shaft deflects upwardly away from the table assembly because of the reactive force of the workpiece. Deflection D_{M} of the motor shaft axis SA is controlled to lower the deflection distance and thereby improve the quality of cut, such as accuracy and precision of cut and quality of the finished cut on the workpiece. During operation, the motor shaft axis deflects less than 5.21 mm toward the top surface of the table, such as, for example, between 0 and 5.21 mm. In an embodiment, the motor shaft axis deflects surface less than 4.92 mm toward the top surface of the table. Also, during operation of the saw assembly, the deflection of the first connecting end portion 152 toward the second connecting end portion 154 is a fraction of the deflection of the motor shaft axis SA. For example, the deflection of the first connecting end portion 152 toward the second connecting end portion 154 can be 50% or less than the deflection of the motor shaft axis SA.

Pivot arm 71 preferably has front and rear ends. At the rear end, pivot arm 71 may be pivotably attached to chopping trunnion 73 so that pivot arm 71 (and motor 78M and housing 78) can pivot about axis 73A. Chopping trunnion 73 is preferably pivotably connected to bevel trunnion 63, which in turn may be fixedly connected to arm body 61.

At the front end, pivot arm 71 may be movably connected to front plate 74. Referring to FIGS. 1-2, 13A-13C and 15, a screw 74KS may be threadingly engaged to pivot arm 71 and/or knob 74K through a slot 74S in the front plate 74. Front plate 74 in turn may be pivotably attached to the front end of arm body 61.

Preferably, axis 73A is substantially horizontal (at the 0° bevel position). Such arrangement allows the pivot arm 71 (and motor 78M and housing 78) to move downwardly in a chopping action so that a user can cut a tile in a chopping motion, or adjust the depth of cut of the cutting wheel 76. The user can fix the depth of cut of the cutting wheel 76 by rotating knob 74K, which in turn lockingly contacts front plate 74.

Persons skilled in the art should recognize that the user can use knob 74K to pivot the pivot arm 71 (and motor 78M and housing 78) downwardly. Alternatively, housing 78 may have a handle 78H extending therefrom to assist in the chopping operation. Preferably handle 78H has a substantially horizontal portion 78HH for the user to grasp.

Referring to FIGS. 1A-2 and 13A, persons skilled in the art should recognize that front plate 74, pivot arm 71 and/or chopping trunnion 73 may pivot together about a bevel axis 63A. Such bevel axis 63A may be substantially horizontal and is preferably substantially perpendicular to axis 73A.

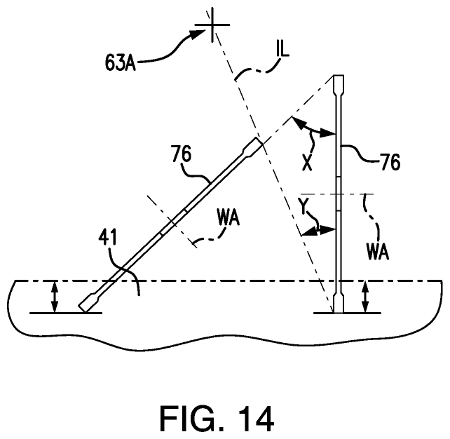

It is preferable that bevel axis 63A not be coplanar with the support surface of table body 41. Furthermore, it is preferable to locate a bevel axis 63A which provides two bevel positions where the distance between the support surface of table body 41 and the end of cutting wheel 76 are substantially equal. Referring to FIG. 14, such bevel axis 63A can be located by first selecting the two bevel positions of cutting wheel 76, and determining the angle difference X between both bevel positions.

In the present embodiment, the two bevel positions are 0° and 45°, whereas angle difference X is 45°. Then, the lowermost corner of cutting wheel 76 when cutting wheel 76 is in the 0° bevel position and which is the corner farthest away from the cutting wheel 76 in the 45° bevel position is selected. An imaginary line IL is drawn from said lowermost corner at an angle Y off the plane containing said lowermost corner and being parallel to cutting wheel 76 when cutting wheel 76 is in the 0° bevel position. Angle Y is preferably half of angle difference X.

Persons skilled in the art will recognize that imaginary line IL intersects the plane of cutting wheel 76 when cutting wheel 76 is in the 45° bevel position at a point above the support surface of table body 41. Bevel axis 63A can then be selected from any point of imaginary line IL, as all points in imaginary line IL will result in a bevel axis which provides two bevel positions where the distance between the support surface of table body 41 and the end of cutting wheel 76 are substantially equal.

Referring to FIGS. 1-2 and 13B, bevel trunnion 63 may include a plate 62 with a slot 62S. A knob 73K extends through slot 62S and threadingly engages chopping trunnion 73. With such arrangement, the user can fix the bevel angle by tightening knob 73K.

A bevel pointer 75 may be attached to the pivot arm 71 and/or front plate 74 by screw 75S so that bevel pointer 75 can pivot jointly therewith. The user can then determine the bevel angle of cutting wheel 76 by looking at the position of bevel pointer 75. Preferably, a bevel angle scale or indicia 611 is disposed on arm body 61 to further assist in the determination of the present bevel angle.

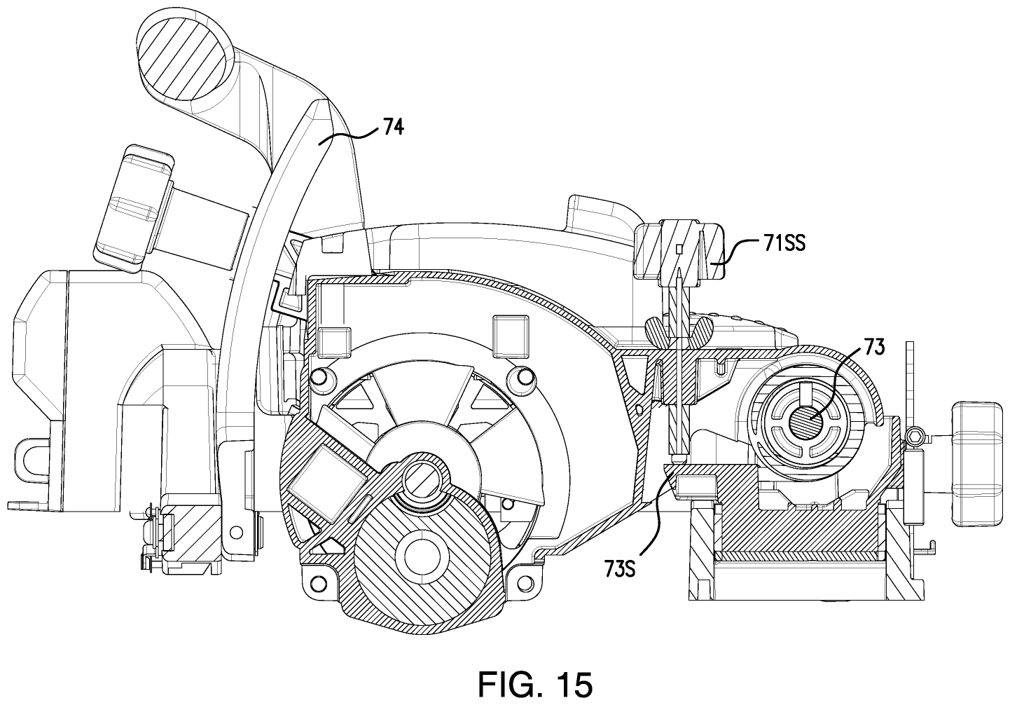

It may be desirable to provide a height adjustment stop mechanism to limit the chopping motion range of cutting wheel 76. Referring to FIG. 15, pivot arm 71 may carry a stop 71SS, such as a boss or bolt, which contacts a surface 73S of chopping trunnion 73. In order to adjust the end of the chopping range, the user need only adjust stop 71SS.

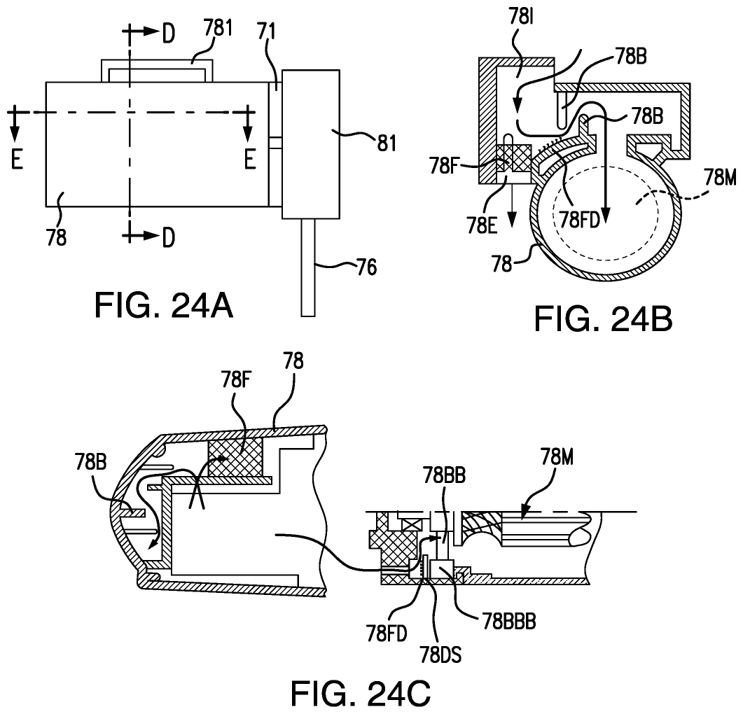

It is preferable to provide an air intake to direct cooling air towards motor 78M. Referring to FIGS. 24A, 24B, 24C, motor housing 78 may have an intake 781 disposed on or near the top of motor housing 78, through which air can enter motor housing 78. Persons skilled in the art should recognize that it is preferable to draw cooling air from the area above motor housing 78, rather than the area below motor housing 78, as the concentration of airborne contaminants is lower in the former than in the latter. Intake 781 preferably faces forwardly and/or away from cutting wheel 76, rather than facing cutting wheel 76.

Motor housing 78 may have first baffles 78B disposed internally to cause changes in the direction or velocity of the airflow. Such interruptions in the steady flow of air will preferably separate particulate matter 78FD from the air and/or to fall within motor housing 78 before they reach motor 78M.

It may also be preferable to dispose a second baffle 78DS between the airflow and the brush box 78BBB, which supports a motor brush 78BB which in turn contacts motor 78M. Such second baffle 78DS would collect particulate matter 78FD from the air by redirecting the airflow away from brush box 78BBB.

It may be advantageous to provide a filter 78F somewhere in the airflow. Filter 78F may be made of open cell foam, or other suitable filtering material. Filter 78F may be disposed near a drain 78E, so that any fluid collected by filter 78F can exit motor housing 78 via the drain 78E. Persons skilled in the art will recognize that, even though drain 78E is disposed on a bottom surface of motor housing 78 and that cooling air with a higher concentration of airborne contaminants may come in through drain 78E, such air may be filtered by filter 78F. Persons skilled in the art should also recognize that it is preferable to design filter 78F so that it can easily be removed through drain 78E and/or intake 781.

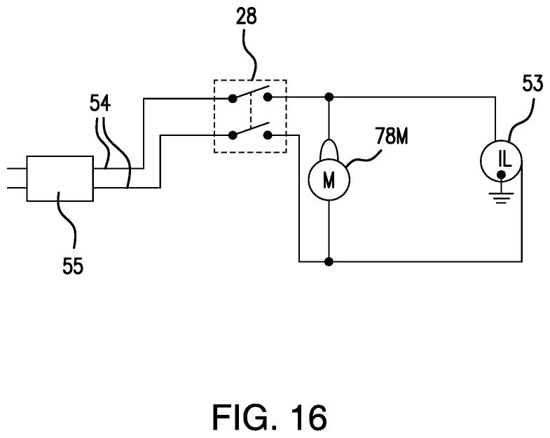

Referring to the circuit schematic of FIG. 16, outlet 53 is preferably disposed in parallel with motor 78M. Outlet 53 and motor 78M preferably receive power via cables 54 which are connected to a plug 55. Preferably, plug 55 is a ground fault circuit interrupt (GFCI) which trips a breaker (thus shutting off power) within about 50 milliseconds if the current exceeds about 5 milliamperes. Persons skilled in the art will recognize that outlet 53 may also be a GFCI outlet.

Switch 28 is preferably a single throw, double pole switch connected to both cables 54 and disposed between plug 55 and outlet 53/motor 78M. It is preferable that switch 28 be placed on arm body 61, so that it remains stationary, even when motor assembly 70 is beveled.

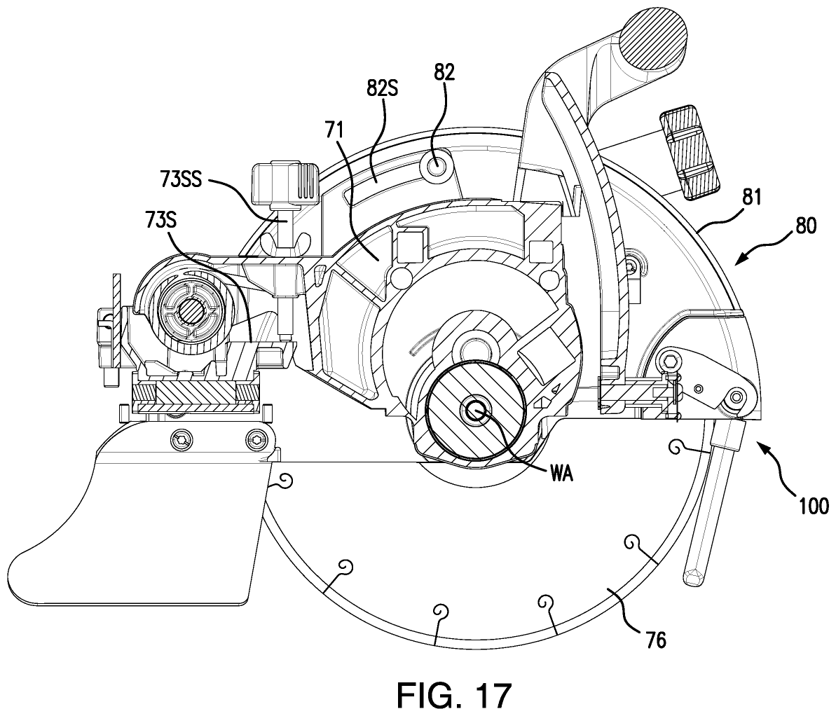

As mentioned above, motor assembly 70 preferably includes guard assembly 80. Referring to FIGS. 1A-2, 13A, 13B and 17A, guard assembly 80 partially covers cutting wheel 76. Guard assembly 80 may include a guard body 81, which partially covers at least the upper portion of cutting wheel 76. Guard body 81 is preferably pivotably attached to pivot arm 71 so that it can rotate about wheel axis WA.

Preferably, guard body 81 has a curved slot 82S, where the radii of the curved slot meet at a center, which is substantially aligned with wheel axis WA. A screw 82 may extend through slot 82S and pivot arm 71 and threadingly engage a knob (not shown). This knob can be rotated to fix the pivotal position of guard body 81 relative to pivot arm 71. This allows guard body 81 to pivot relative to pivot arm 71 to cover the shaft 72 when a smaller cutting wheel is installed thereon. In addition, such arrangement allows the guard body 81 to remain in the same pivotal position relative to cutting wheel 76 regardless of the cutting wheel diameter. This is especially helpful for maintaining the fluid delivery assembly, discussed below, aligned with cutting wheel 76.

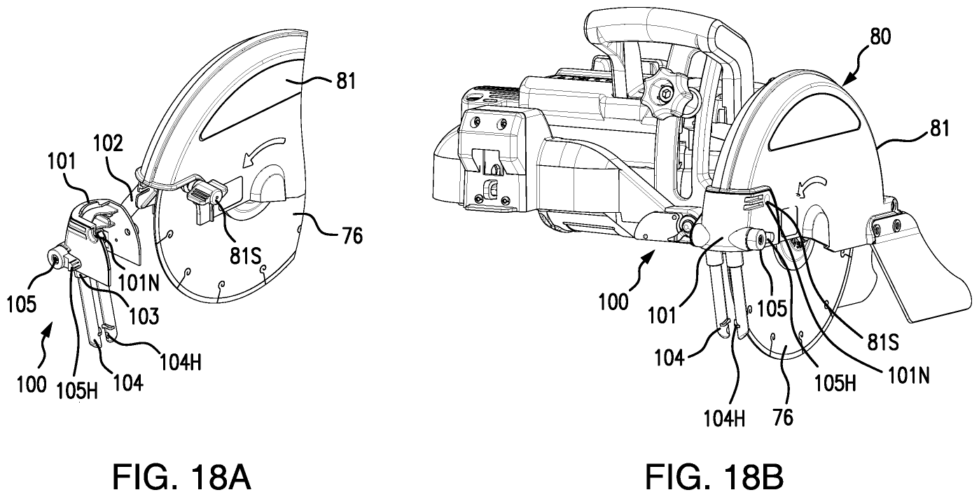

Referring to FIGS. 1 and 18A-21, guard assembly 80 may support fluid delivery assembly 100, which directs water and/or other fluids towards cutting wheel 76 for cooling cutting wheel 76 during the cutting operation. Fluid delivery assembly 100 comprises a hose 102 which is connected to and feeds fluid to a valve body 101.

Valve body 101 may be attached to guard body 81. In particular, valve body 101 may have a notch 101N which receives a screw 81S threadingly engaged to guard body 81. Valve body 101 in turn may send the fluid to two nozzles 104, each nozzle 104 being disposed on opposite sides of cutting wheel 76. Nozzles 104 in turn have holes 104H through which the fluid exits.

Nozzles 104 are preferably carried by a carrier 103, which may be pivotably attached to valve body 101. Carrier 103 may be connected to pivoter 105. This enables the user to rotate nozzles 104 and/or carrier 103 to a desired position towards or away from cutting wheel 76 by rotating pivoter 105. Pivoter 105 preferably has a handle 105H to facilitate such rotation.

Preferably, nozzles 104 and/or carrier 103 can be biased away from cutting wheel 76 so that the fluid exiting through holes 104H does not contact cutting wheel 76. This placement advantageously reduces the amount of fluid misting.

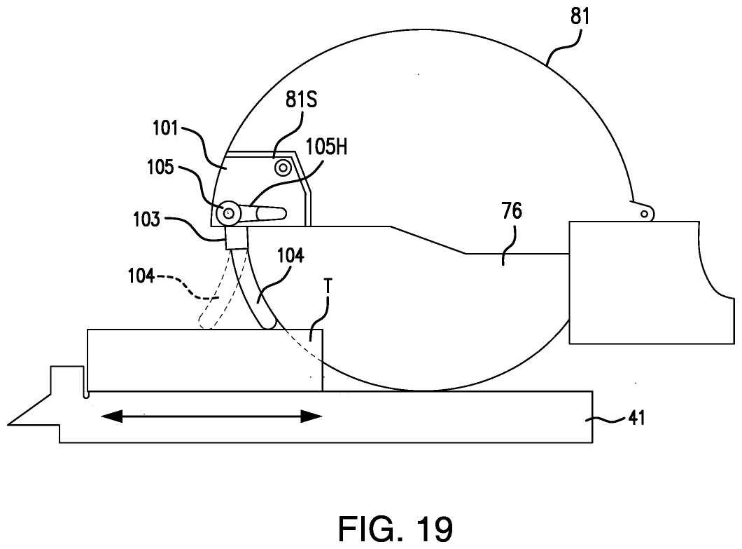

It is preferable that nozzles 104 may be made of an elastic or resilient material such that, when a workpiece T is pushed into contact with cutting wheel 76, workpiece T flexes nozzles 104 as shown in FIG. 19, so the exiting fluid can contact and/or cool cutting wheel 76. Making nozzles 104 of an elastic or resilient material may also prevent damage to nozzles 104 and/or fluid delivery assembly 100 when the workpiece T is returned to the original position as nozzles 104 would safely flex out of the way, as shown in the broken line position in FIG. 19.

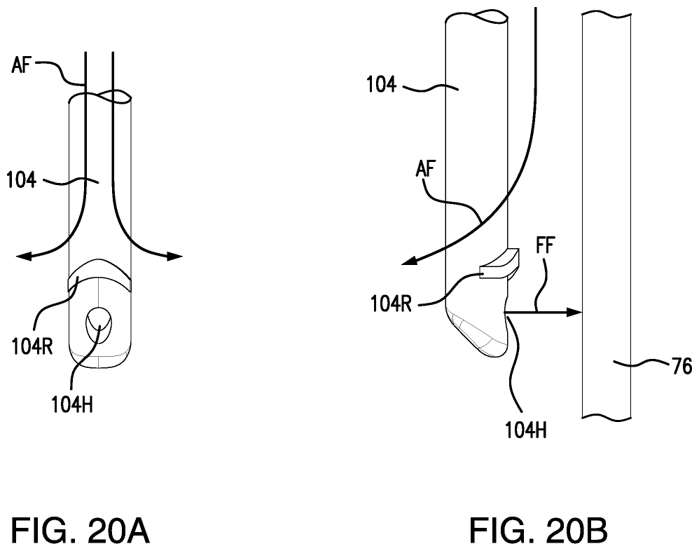

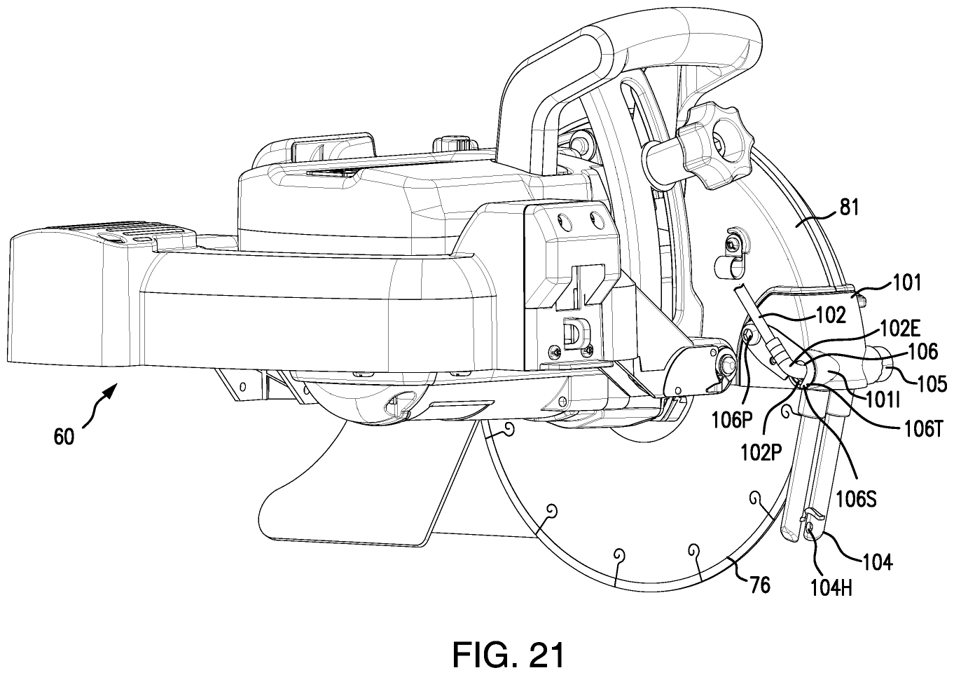

Referring to FIGS. 20-21, each nozzle 104 may have a rib 104R protruding therefrom. Rib 104R is preferably disposed above hole 104H to redirect the air flow AF created by the rotating cutting wheel 76. Such redirection allows the fluid flow FF exiting through nozzle hole 104H to remain in a laminar-type flow until the fluid contacts cutting wheel 76 without disturbance from air flow AF, thus reducing fluid misting.

It is preferable to provide an easy means for separating hose 102 from valve body 101. Referring to FIG. 21, hose 102 may include an elbow 102E, which has a plate 102P. Plate 102P can be inserted into an input 101I of valve body 101. A plate 106 rotatably attached to valve body 101 may have a slot 106S which captures plate 102P to maintain hose 102 connected to valve body 101. Persons skilled in the art will recognize that plate 106 may be rotatable attached to valve body 101 by a screw 106P. Persons skilled in the art may also recognize that it is preferable to provide plate 106 with a tab 106T to enable the user between the retaining position and the plate bypassing position shown in FIG. 21.

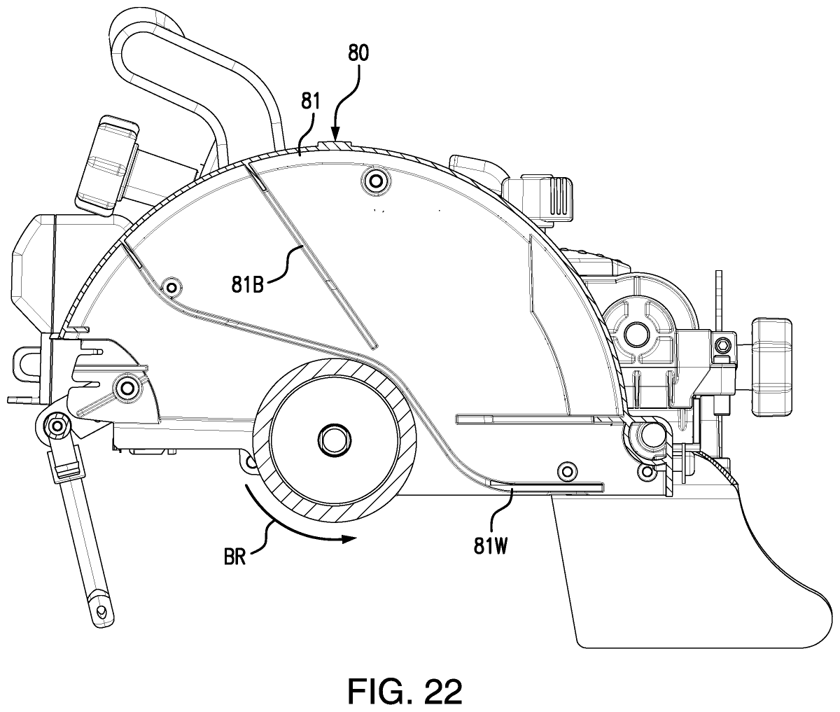

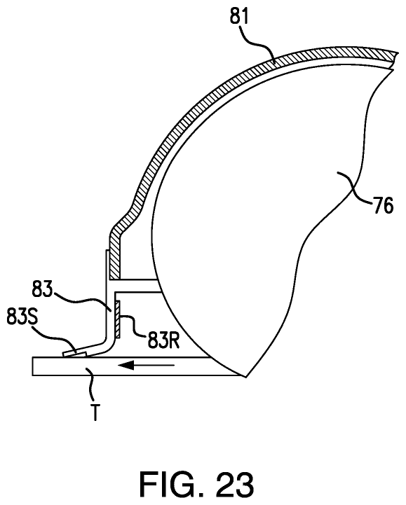

Guard assembly 80 may also have other means for controlling fluid flow. For example, referring to FIG. 22, guard body 81 may have internal baffles 81B and/or a bottom wall 81W, which may be disposed as close as possible to cutting wheel 76. As cutting wheel 76 rotates along path BR, it carries fluid, fluid spray and/or mist. Internal baffles 81B and/or bottom wall 81W catch the fluid, spray and/or mist off the rotating cutting wheel 76 and redirect such fluid to the rear of guard body 81, where it can be released into base 11.

Guard assembly 80 may also have a flapper 83 attached to guard body 81. Flapper 83 may be made of rubber. Flapper 83 preferably has an upper portion 83R with substantially vertical ribs and a lower portion 83S without ribs. Such arrangement is advantageous as the ribs on the upper portion reduces the amount of mist created when fluid strikes flapper 83, whereas the lower portion 83S can lay flush on workpiece T and act as a wiper.

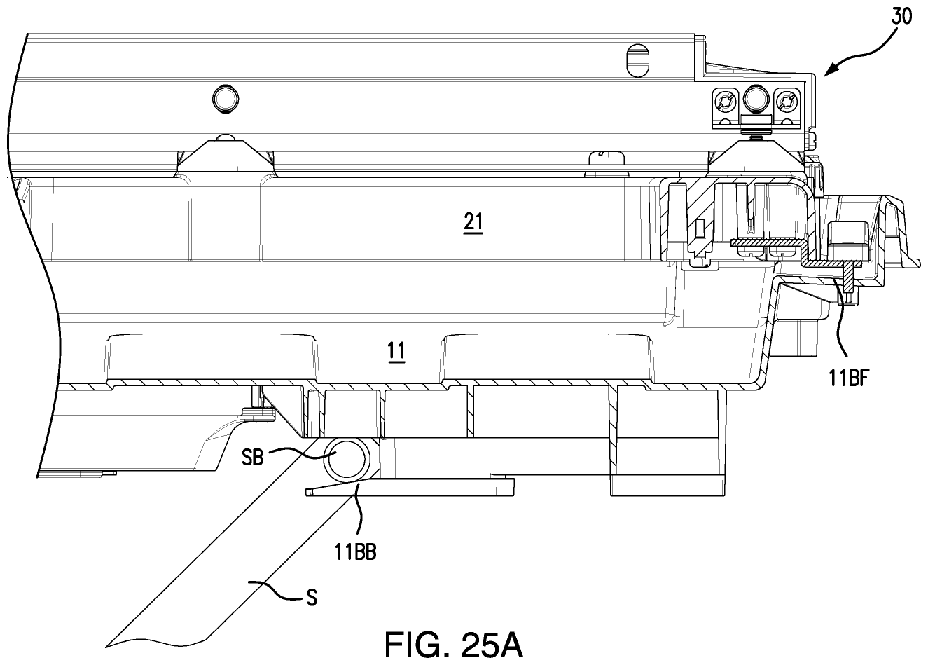

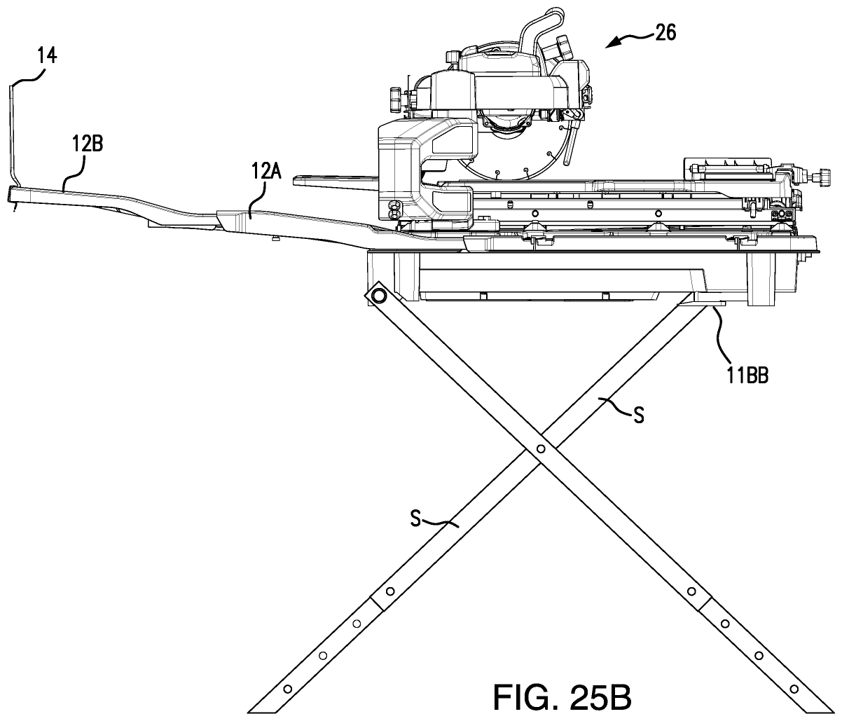

Referring to FIGS. 25A and 25B, base 11 (and thus tile saw 10) may be supported by a stand S. Preferably, base 11 has at least one anti-tip bracket 11BB that may extend from an underside of the base 11. The frame assembly 20 can also have a corresponding anti-tip bracket 11BF that extends rearwardly from the base 11. The anti-tip brackets include a bracket on the base and a bracket on the frame assembly 20. The base bracket 11BB and the frame bracket 11BF keep the saw from tipping if too much weight is put on the table while the table is extended beyond the cutting wheel. Stand S has beams SB which extend underneath the base and are held by the brackets 11BB, 11BF. The beams SB can have any shape that corresponds to the contours of the brackets 11BB, 11BF for a secure fit. The base bracket 11 BB can be a plastic member that is attached to the base by screws. The frame bracket 11BF can be a metal bracket that is attached to the frame by screws.

Persons skilled in the art should recognize that, if the stand S has a linkage that limits the distance between beams SB, one beam SB may be disposed on one bracket 11BB, while the other beam SB may just contact the underside of base 11.

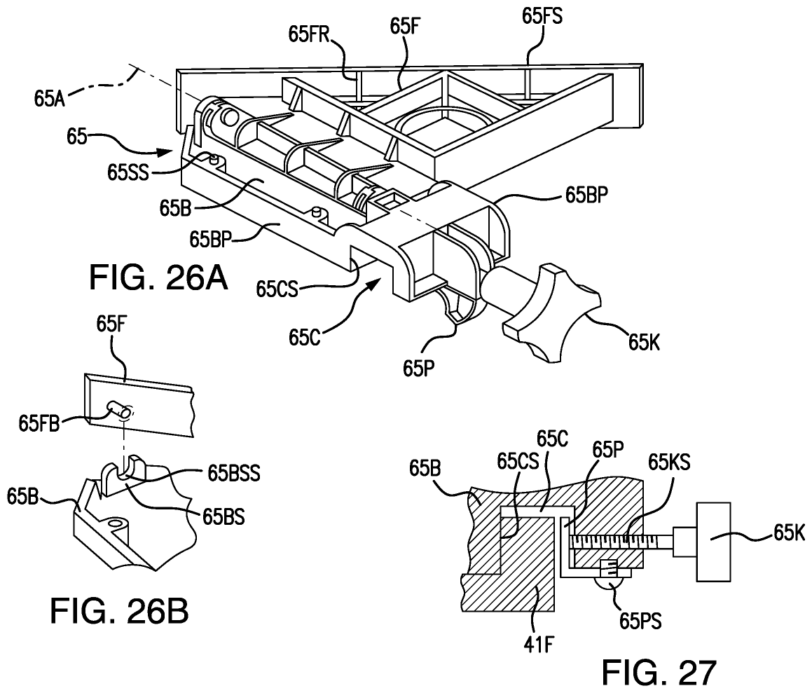

Referring to FIGS. 26A, 26B and 27, an angle guide assembly 65 may be attached to table body 41 to help guide a workpiece T disposed on table body 41 into cutting wheel 76. Angle guide assembly 65 may have a guide body 65B that is disposable on table body 41. Preferably, guide body 65B is clamped onto fence 41F.

Guide body 65B may have a clamping channel 65C which receives fence 41F. Clamping channel 65C may include a surface 65CS which is preferably substantially parallel to fence 41F. Guide body 65B may also include a movable plate 65P which is moved into contact against fence 41F for sandwiching the fence 41F between surface 65CS and plate 65P. Plate 65P may be moved in by a knob 65K which is preferably attached to a screw 65KS, which in turn is preferably threadingly engaged to guide body 65B and may contact plate 65P.

Guide body 65B may have a surface 65BP on one side thereof, and preferably two surfaces 65BP on both sides thereof. Surfaces 65BP are preferably substantially perpendicular to surface 65CS. Accordingly, guide body 65B can be attached to table body 41 and a workpiece T can be disposed against the surface 65BP. Persons skilled in the art will recognize that, if two surfaces 65BP are provided on both sides of guide body 65B, the user could rest a workpiece T against a surface 65BP regardless of which side of groove 41G the guide body 65B is disposed.

Angle guide assembly 65 may also have an angled fence 65F. Angled fence 65F may be pivotably attached to guide body 65B, as shown in FIG. 26A, so that it can be pivoted to either side of guide body 65B. Preferably, angled fence 65F is pivotable about an axis 65A which is substantially parallel to surfaces 65BP and/or substantially perpendicular to surface 65CS.

Alternatively, angled fence 65F may be removably disposed on guide body 65B, as shown in FIG. 26B. In this case, angled fence 65F would include a boss 65FB, which can be slid into a slot 65BSS of support wall 65BS. The user can thus remove angle fence 65F, rotate it, and disposed on the other side of guide body 65B by sliding boss 65FB into slot 65BSS. Persons skilled in the art will recognize that angled fence 65F may have two bosses 65FB received into rear and front slots 65BSS of guide body 65B.

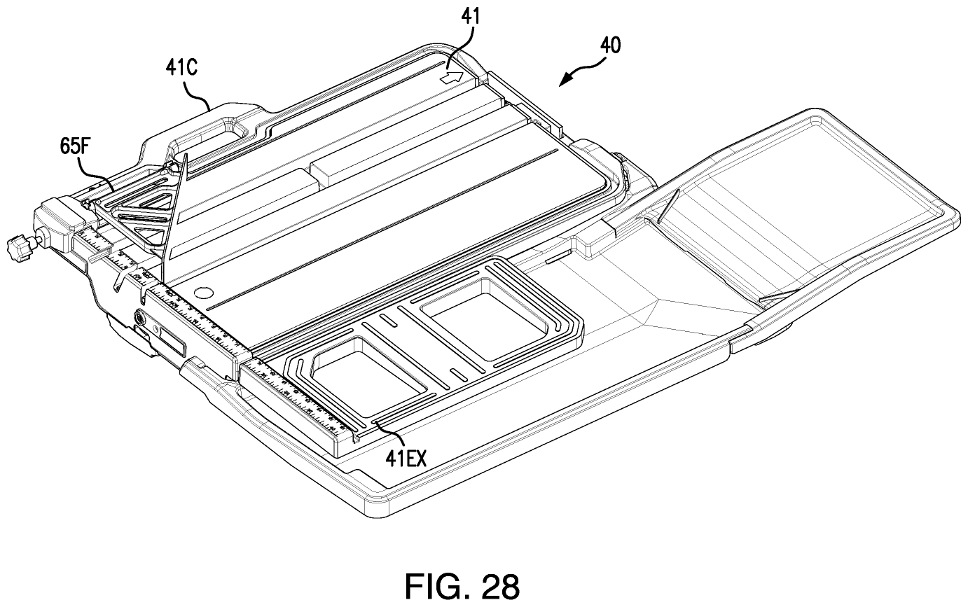

As shown in FIG. 28, angled fence 65F has a surface 65FS which is preferably substantially perpendicular to the support surface of table body 41, though persons skilled in the art will recognize that surface 65FS may be angled relative to table body 41. In addition, surface 65FS is preferably angled relative to axis 65A and/or surfaces 65BP. Preferably, surface 65FS is disposed at an angle of 45° relative to axis 65A and/or surfaces 65BP, so that the user can support a workpiece T disposed on table body 41 at an angle.

Persons skilled in the art will recognize that providing an angled fence 65F that can be moved between both sides of guide body 65B will enable the user to support a workpiece T disposed on table body 41 at an angle regardless of which side of groove 45G guide body 65B is disposed.

Angled fence 65F may have support ribs 65FR for added strength and/or stability.

Guide body 65B may also carry set screws 65SS for properly aligning the surface 65FS relative to table body 41 and/or surfaces 65BP.

While aspects of the present invention are described herein and illustrated in the accompanying drawings in the context of a tile saw, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

1. A saw assembly comprising:
a base;
a frame assembly disposed on the base;
a rail assembly disposed on the frame assembly, the rail assembly having a longitudinal axis, a first end and a longitudinally opposite second end;
a support assembly disposed on at least one of the base and the frame assembly and comprising a motor, and a cutting wheel driven by the motor, the cutting wheel having a cutting wheel axis that lies in a cutting wheel axis plane;
a table assembly having a table body, the table assembly movably disposed on the rail assembly between a first cantilevered position with respect to the frame assembly at the first end of the rail assembly, and a second cantilevered position with respect to the frame assembly at the second end of the rail assembly; and
a plurality of wheels serially arranged on the table body to move the table assembly along the rail assembly between the first cantilevered position wherein at least two of the plurality of wheels are moved beyond the first end of the rail assembly, and the second cantilevered position wherein at least two of the plurality of wheels are moved beyond the second end of the rail assembly.

2. The saw assembly according to claim 1, wherein the at least two of the plurality of wheels in the first cantilevered position are different from the at least two of the plurality of wheels in the second cantilevered position.

3. The saw assembly according to claim 1, wherein the plurality of wheels comprises:
a first end wheel disposed at one end of the table body and having a first end wheel axis that lies in a first end wheel axis plane,
a second end wheel disposed at an opposite end of the table body and having a second end wheel axis that lies in a second end wheel axis plane, and
middle wheels located between the first end wheel and the second end wheel, and
wherein the distance between the at least one of the first end wheel or second end wheel, and an adjacent middle wheel, is greater than the distance between adjacent middle wheels.

4. The saw assembly according to claim 3, wherein in the first cantilevered position in which the table assembly is cantilevered to a maximum cantilevered span at the first end of the rail, the distance between the cutting wheel axis plane and the first end wheel axis plane is greater than the length of the rail.

5. The saw assembly according to claim 3, wherein in the second cantilevered position in which the table assembly is cantilevered to a maximum cantilevered span at the second end of the rail, the distance between the cutting wheel axis plane and the first end wheel axis plane is less than the length of the rail.

6. The saw assembly according to claim 1, wherein the length of the table assembly is greater than the distance between the cutting wheel axis plane and a plane defining a longitudinal end of the rail.

7. The saw assembly according to claim 1, wherein in the first and second cantilevered positions, more than 50% of the table assembly is movable beyond the first end of the rail assembly and the second end of the rail assembly.

8. The saw assembly according to claim 1, wherein in the first cantilevered position, more than 75% of the table assembly is movable beyond the first end of the rail assembly.

9. The saw assembly according to claim 1, wherein the table assembly comprises a carrying handle.

10. A saw assembly comprising:
a base;
a frame assembly disposed on the base;
a rail assembly disposed on the frame assembly, the rail assembly having a longitudinal axis and a rod disposed along the longitudinal axis, the rod having a first end and an opposite second end;
a support assembly disposed on at least one of the base and the frame assembly and comprising a motor, and a cutting wheel driven by the motor;
a table assembly having a table body, the table assembly movably disposed on the rail assembly between a first cantilevered position with respect to the frame assembly at the first end of the rod, and a second cantilevered position with respect to the frame assembly at the second end of the rod; and
a plurality of wheels serially arranged on an underside of the table body, to move the table assembly along the rod between the first cantilevered position wherein at least two of the plurality of wheels are moved beyond the first end of the rod and the second cantilevered position wherein at least two of the plurality of wheels are moved beyond the second end of the rod.

11. A saw assembly comprising:
a base;
a frame assembly disposed on the base;
a rail assembly disposed on the frame assembly, the rail assembly having a longitudinal axis, and a contact portion disposed along the longitudinal axis and having a first end and an opposite second end;
a support assembly disposed on at least one of the base and the frame assembly and comprising a motor having a rotatable motor shaft, and a cutting wheel driven by the motor on the motor shaft, the cutting wheel having an axis that lies in a cutting wheel axis plane;
a table assembly having a table body, the table assembly movably disposed on the rail assembly between a first cantilevered position with respect to the frame assembly at the first end of the contact portion, and a second cantilevered position with respect to the frame assembly at the second end of the contact portion;
a plurality of wheels serially arranged on the table body to move the table assembly along the contact portion between the first cantilevered position wherein at least two of the plurality of wheels are moved beyond the first end of the contact portion, and the second cantilevered position wherein at least two of the plurality of wheels are moved beyond the second end of the contact portion.

12. The saw assembly according to claim 11, wherein the plurality of wheels comprises:
a first end wheel disposed at one end of the table body and having a first end wheel axis that lies in a first end wheel axis plane,
a second end wheel disposed at an opposite end of the table body and having a second end wheel axis that lies in a second end wheel axis plane, and
middle wheels located between the first end wheel and the second end wheel, and
wherein the distance between each end wheel and an adjacent middle wheel is greater than the distance between adjacent middle wheels.

13. The saw assembly according to claim 12, wherein in the first cantilevered position in which the table assembly is cantilevered to a maximum cantilevered span at the first end of the contact portion, the distance between the cutting wheel axis plane and the first end wheel axis plane is greater than the length of the contact portion.

14. The saw assembly according to claim 12, wherein in the second cantilevered position in which the table assembly is cantilevered to a maximum cantilevered span at the second end of the contact portion, the distance between the cutting wheel axis plane and the first end wheel axis plane is less than the length of the contact portion.

15. The saw assembly according to claim 12, wherein in the first cantilevered position, a distance between the cutting wheel axis plane and the first end wheel axis plane at the maximum cantilevered span position is at least 36 inches.

16. The saw assembly according to claim 12, wherein the contact portion is a rod.

17. A saw assembly comprising:
a base;
a frame assembly disposed on the base;
a rail assembly disposed on the frame assembly, the rail assembly including a rail having a longitudinal axis, a first end and an opposite second end;
a support assembly disposed on at least one of the base and the frame assembly and comprising a motor having a rotatable motor shaft, and a cutting wheel driven by the motor on the motor shaft, the cutting wheel having an axis that lies in a cutting wheel axis plane;
a table assembly having a table body, the table assembly movably disposed along the rail to travel to a first cantilevered position at a first end of the rail and a second cantilevered position at a second end of the rail opposite to the first end, the table assembly having a table length;
a plurality of wheels serially arranged on an underside of the table body, and movable along the rail to at least one of a first and second cantilevered position, the plurality of wheels including a first end wheel having a first end wheel axis and a second end wheel having a second end wheel axis, the first and second end wheels disposed at opposite ends of the table body,
wherein a ratio of the distance between the first end wheel axis and the second end wheel axis to the length of the rail is less than 1.25.

18. The saw assembly according to claim 17, wherein a ratio of the distance between the first end wheel axis and the second end wheel axis to the length of the rail is less than 1.0.

19. The saw assembly according to claim 17, wherein a ratio of the distance between the first end wheel axis and the second end wheel axis to the length of the rail is less than 0.85.

20. The saw assembly according to claim 17, wherein a ratio of the distance between the first end of the table body at the maximum cantilevered span position at the first end of the rail, and the second end of the table body at the maximum cantilevered span position at the second end of the rail, to the length of the rail is greater than 1.0.

21. The saw assembly according to claim 17, wherein a travel length of the table assembly along the rail is about two times the length of the rail.

22. The saw assembly according to claim 17, wherein a cantilevered portion of the table assembly is about 70% of the length of the table assembly.

23. The saw assembly according to claim 17, wherein the length of the table assembly is substantially equal to the length of the rail.

24. The saw assembly according to claim 17, wherein the cutting wheel and motor are disposed above the table assembly and the saw assembly cuts tile of at least 36 inches oblique.

25. The saw assembly according to claim 17, wherein the cutting wheel and motor are disposed above the table assembly and the saw assembly cuts tile of at least 25 inches square.

26. The saw assembly according to claim 17, wherein the ratio between a cutting wheel diameter and an oblique tile distance is about 0.28.

27. A saw assembly comprising:
a base;
a frame assembly disposed on the base;
a rail assembly disposed on the frame assembly, the rail assembly having a longitudinal axis;
a support assembly disposed on at least one of the base and the frame assembly and comprising a motor having a rotatable motor shaft, and a cutting wheel driven by the motor on the motor shaft, the cutting wheel having an axis that lies in a cutting wheel axis plane;
a table assembly movably disposed along the rail assembly and having a first cantilevered position with respect to the frame assembly at a first end of the rail assembly and a second cantilevered position with respect to the frame assembly at a second end of the rail assembly opposite to the first end; and
a plurality of wheels serially arranged on the table assembly to move the table assembly to the first and second cantilevered positions, each of the plurality of wheels including a first end wheel located at one end of the table assembly, the first end wheel having a first end wheel axis that lies in a first end wheel axis plane,
wherein in the first cantilevered position, the table assembly is cantilevered to a maximum cantilevered span position, and
wherein in the maximum cantilevered span position, a ratio of the distance between the cutting wheel axis plane and first end wheel axis plane to the length of the rail is greater than one.

28. A saw assembly comprising:
a base;
a frame assembly disposed on the base;
a rail assembly disposed on the frame assembly, the rail assembly having parallel first and second rails arranged on the frame assembly, each of the first and second rails having a first end and an longitudinally opposite second end;
a support assembly disposed on at least one of the base and the frame assembly and comprising a motor having a rotatable motor shaft, and a cutting wheel driven by the motor on the motor shaft, the cutting wheel having an axis that lies in a cutting wheel axis plane;
a table assembly having a table body, the table assembly movably disposed on the rail assembly and having a first cantilevered position with respect to the frame assembly at the first end of the first and second rails and a second cantilevered position with respect to the frame assembly at the second end of the first and second rails; and
a plurality of bearings serially arranged on the table assembly, to support the table assembly along the first and second rails between the first cantilevered position wherein at least two bearings are moved beyond the first end of the first and second rails and the second cantilevered position wherein at least two bearings, are moved beyond the second end of the first and second rails.

29-72. (canceled)
